(19) United States
(12) Patent Application Publication
(10) Pub. No.: US 2010/0304121 A1
(43) Pub. Date: Dec. 2, 2010

(54) POROUS STRUCTURE FOR VENTILATION STOPPER

(75) Inventors: Masanori Naritomi, Tokyo (JP); Naoki Andoh, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TAISEI PLAS CO., LTD., Tokyo (JP)

(21) Appl. No.: 12/783,596

(22) Filed: May 20, 2010

(30) Foreign Application Priority Data
May 21, 2009 (JP) 2009-123608

(51) Int. Cl. B32B 3/26; B32B 25/00

(52) U.S. Cl. 428/314.2; 428/338

(57) ABSTRACT

The present invention provides an air-permeable porous structural body that can be used for a vent plug or the like and imposes a low environmental load in waste treatment or the like after use, and also provides a vent plug using the porous structural body. Further, the invention provides an air-permeable porous structural body that can be molded by injection molding that has high productivity. The porous structural body has an overall structure entirely occupied by a structure composed of an infinite number of spherical or ellipsoidal cavities having a diameter of 1 μm to 100 μm. Holes are open in cavity walls and the cavity is linked to another cavity by the holes. The inside of the porous structural body is constituted by communicating open passages that pass in a meandering fashion between the inlet and outlet of the porous structural body and are composed of a plurality of cavities that are joined with each other in a chain configuration, and chain closed passages that are composed of one cavity or a plurality of cavities and connected to the communicating open passages. Further, 50 to 60% of the cavities per unit cube are cavities having a diameter of less than 10 μm.

### BACKGROUND OF THE INVENTION

1. Field of the Invention

The present invention relates to a structure of a porous structural body for a vent plug. More particularly, the present invention relates to a porous molded article for ensuring the internal pressure and preventing water penetration that is used in the field of moving machines, electronic devices, electric apparatuses, general machinery, illumination devices and other general manufacturing fields, and also to a porous structural body of a vent plug for a semi-sealed container provided with the porous molded article. Even more particularly, the present invention relates to a vent plug for use in a component that is required to be sealed, for example, a case component of headlamp or backlight of an automobile, and a case of an electronic device or a rotary machines such as a motor of an electric appliance, and to a material therefor.

2. Description of the Related Art

Light-emitting bodies, electronic devices, relay circuits, motors, and other drive components are often sealed in a porous molded article having water repellency with the object of protecting from penetration of dust and water. Where such elements or components are entirely sealed, undesirable variations in air pressure caused by temperature variations occur inside the element or component. A vent plug that is permeable with respect to the air and water vapors and demonstrates sealing ability with respect to liquid water is typically disposed to prevent such internal pressure fluctuations in sealed containers. The container is thus semi-sealed by using a vent plug.

Such a vent plug is almost unnoticeable. However, the vent plugs are used in many articles that come into contact with people on daily basis. For example, headlamps of automobiles are large transparent resin moldings and an electric lamp is fitted therein. When light is radiated by such a headlamp, the temperature inside thereof becomes as high as about 100° C., whereas when the headlamp is switched off, the temperature inside thereof can be below a freezing point in the winter in cold regions and mountainous areas. Where such a headlamp is completely sealed, no significant trouble is caused by water retained inside thereof when the headlamp is turned off.

However, when the headlamp is turned on, pressure inside thereof rises due to evaporation of water retained inside the headlamp. In the winter, the air pressure inside the headlamp drops with the decrease in the external air temperature. Such cycles of pressure increase and decrease inside the head lamp continuously apply cyclic thermal stresses to the housing produced from a resin and the like and are highly probable to result in a fracture. A vent plug is designed to prevent such a fracture. At present, nonwoven fabrics manufactured from a polytetrafluoroethylene resin (referred to hereinbelow as “PTFE”) are used as venting portions of the vent plugs.

Injection molded articles manufactured from ABS resins (referred to hereinbelow as “ABS”), polycarbonate resins (referred to hereinbelow as “PC”), and polybutylene terephthalate resins (referred to hereinbelow as “PBT”). Such an injection molded article is provided with a through hole that passes through from the inside to the outside of the article, and a nonwoven fabric made from PTFE is bonded so as to close the through hole. The function of the nonwoven fabric is to allow the air and water vapors to pass, while blocking water droplets. This effect is attained by using water repellency of PTFE. The performance of vent plugs using the presently available PTFE nonwoven fabrics causes no significant problems, but bonding defects sometimes occur when the nonwoven fabric is bonded to a structural body made from a resin when the vent plug is manufactured.

PTFE is a resin that is inherently difficult to bond. Even if the adhesive used therefor is improved, the reliability of the bonding process is still low. In other words, after the PTFE vent plugs have been bonded to the housings or the like, all the products have to be inspected. Another problem arises when an automobile or the like is discarded. Because PTFE is not a thermoplastic resin, when the headlamp is melted without removing the nonwoven fabric after an electric lamp has been removed, the PTFE is not melted. Accordingly, in an extruder for reusing the molten resin, a mesh that is a filtration material should be installed to filter out and separate the resin. Furthermore, the filtration material should be periodically disassembled and cleaned.

It has also been indicated that when the nonwoven fabric is thermally decomposed, hydrogen fluoride is generated and wear of metal parts of the extrusion machine is accelerated. Further, when a resin mixture containing PTFE is burned as a fuel, hydrogen fluoride is generated. The generated hydrogen fluoride damages the furnace and can lead to unforeseen accidents. In addition, since fluorine is a halogen similar to bromine or chlorine that produce dioxins, there is a certain uneasiness associated therewith, although the issue has not yet been clarified. Vent plugs are very small parts and even if these concerns are valid, the vent plugs apparently should not be considered as an environmental problem, even at a basic level, in the sense of creating an environmental load.

However, in the automobile industry, this issue also causes concerns and resolution thereof is obviously a good idea. The inventors have conducted research and development aimed at obtaining with a very simple means an air-permeable structural material that can replace the above-described vent plugs that are presently used. The porous structural body for a vent plug in accordance with the present invention has been created as a material that is mechanically similar to the presently available products, but is entirely a thermoplastic resin, involves no process that degrades reliability, such as bonding, causes no environment problems and can be produced at a low cost.

In the past, the inventors of the present invention have successfully produced a compound of pentaerythritol and polypropylene (referred to hereinbelow as “PP”) and fabricated a porous molded article using the compound. More specifically, a molded article has been fabricated by injection molding the compound as a starting material, and the molded article has been immersed in warm water to elute water-soluble components contained in the molded article and then dried. As a result, a porous molded article that excelled in gas permeability has been fabricated. However, this porous molded article has insufficient strength and the porous molded article is not good enough to be used as a replacement for the available vent plugs.

For this reason, the inventors pinned their hopes on porous molded bodies of a PBT system that can be expected to demonstrate high strength and better heat resistance than the materials for the above-described porous molded articles. The inventors focused their attention at a method for manufacturing a porous body using pentaerythritol that has already been disclosed. Thus, Japanese Patent Application Laid-Open No. 2001-2825 discloses a method for producing a porous molded article by melting pentaerythritol and a thermoplastic resin at a temperature equal to or higher than the melting point of pentaerythritol, injection molding the melt as a starting material, and immersing the molded article in a certain alcohol-soluble solvent to extract the pentaerythritol.

The inventors of the present invention have already fabricated a vent plug by a method different from the conventional methods and indicated that the vent plug demonstrates sufficient performance (Japanese Patent Applications Laid-open Nos. 2008-7534 and 2010-24361). In the fabrication process, first, a mixture (compound) of PBT, pentaerythritol, and a small amount of a third component is produced, the mixture is injection molded as a starting material, the molded article thus obtained is subjected to extraction by immersion into hot water, pentaerythritol is removed, and a porous body is obtained. An emulsion-type water repellent of a polytetrafluoroethylene resin (PTFE) system or a methyl silicon polymer compound is dissolved in a low-boiling solvent such as benzine to obtain a solution, and the porous body is immersed into the solution, pulled out therefrom, and dried in air to evaporate the solvent. With such a process, using PTFE is environmentally undesirable for the above-described reasons, production stability is poor, and a product having a uniform water repellent effect is difficult to obtain.

Accordingly, a methyl silicon polymer is used and caused to be adsorbed by the entire surface (outer surface and inner surface) of the porous material. The porous material is then fired at a temperature about 150° C. to obtain a certain arrangement or methyl silicone polymer or impart methyl groups with outward orientation, thereby increasing water repellency. At the same time, end portions of the molecules are bonded, molecular weight is increased, and the material is prevented from moving from the adsorption positions on the PBT substrate. As a result, a porous body having semi-permanent water repellency (water resistance) is obtained. None of the materials used is particularly expensive, reliability is higher than that of the above-described PTFE vent plug, the product is environmentally friendly, and cost is reduced.

PBT demonstrates excellent properties such as high thermal deformation temperature, high rigidity, and excellent electric properties and mechanical properties and has been used for electric components for automobiles, such as lamp sockets, fuse cases, and harness connectors. It has also found applications for seat belt components and mechanical parts such as gears. Accordingly, the inventors of the present invention decided to produce a vent plug with a high gas permeability and also high resistance to water pressure by using PBT that has found such general use. As a result, a product with a low environmental load that is described hereinabove and causes concerns can be realized and recycling thereof can be easily performed.

The inventors have prepared samples and tested specific fabrication methods for producing vent plugs by using PBT. However, the test results demonstrated that a large number of issues that can be expected to cause problems are associated with combinations of pentaerythritol and PBT. Before addressing these expected problems, chemical properties of pentaerythritol will be described. Commercial pentaerythritol usually includes dimers at about 10 wt. %. When the temperature of pentaerythritol crystals obtained by recrystallization or the like and having very high purity is smartly and rapidly raised, the crystals somehow reach a melting point (assumed to be about 250° C.) and melt.

However, in the usual heating process, a dehydration polycondensation reaction occurs before the melting point is reached, water vapors are generated, and dimers are produced and melted. All the pentaerythritol products that are mass produced and commercially available include dimers. Such pentaerythritol includes dimers at about 10 wt. % and has a melting point of about 190° C. The dimer ratio of about 10 wt. % is an equilibrium value of monomers and dimers at 190° C. According to chemical manuals and the like, the melting point of pentaerythritol with a purity of 100% is about 250° C., but pentaerythritol with a purity of 100% cannot be commercially acquired for the reasons mentioned above.

Further, for most chemists, using the commercial pentaerythritol as a starting material and purifying it to a purity of 100% would not be impossible, but from the standpoint of the present invention such purification is meaningless. This is because the dimers are soluble in water, and although they are contained in the molded article, the dimers are similarly extracted by a solvent (for example, water, hot water (warm water), and ethanol) that dissolves pentaerythritol. For this reason, the pentaerythritol referred to in the description of the present invention is commercial pentaerythritol and such pentaerythritol is considered to be the object of use. Thus, the essential melting point of pentaerythritol is about 190° C.

Another important issue is that when pentaerythritol is heated to a temperature equal to or higher than 190° C., the ratio of dimers in the equilibrium state exceeds 10% and new dimerization or trimerizaiton is started. When the inventors loaded commercial pentaerythritol into an autoclave and raised the temperature at a rate of about 2° C./min, melting was observed at a temperature above 190° C., and the internal pressure increased rapidly at 225 to 240° C. This is clearly because rapid generation of steam has occurred. Therefore, when pentaerythritol is used as a starting material and a compound is produced with an extruder or hot rolls, the operation conducted at a temperature of equal to or higher than at least 230° C. clearly generates a large amount of steam and is very dangerous.

Thus, it is clear that the temperature that is to be used in admixing a thermoplastic resin to pentaerythritol, melting, and compounding should be within a range of 190 to 230° C., and heating should be conducted smoothly. Furthermore, problems that can be foreseen when PBT is used as a thermoplastic resin will be described below. First, the melting point of PBT is as high as 225° C. This temperature falls within a range in which new dehydration dimerization of the commercial pentaerythritol is started. In order to prevent the dehydration dimerization from inhibiting the compound formation process, the operations should be conducted at a temperature equal to or lower than 230° C., preferably at a temperature up to 225° C.

This is hardly the temperature at which PBT is completely melted, and whether PBT can be safely melted becomes a problem. This is the first barrier, and even if a case is assumed in which this barrier can be overcome, it will merely mean that PBT will be dissolved in molten pentaerythritol. Chemical consideration of this possibility reveals the following. PBT, that is, a polyester, that is, an ester, is inherently alcohol-philic and therefore it has been considered highly probable that PBT will be unexpectedly easily dissolved in molten pentaerythritol, which is a hot alcohol. When PBT is dissolved, following this assumption, in molten pentaerythritol, it is assumed that two novel obstacles will be encountered.

The first obstacle is that where an ester is co-present in a large amount of liquid alcohol at a high temperature equal to or higher than 200° C., an ester decomposition reaction occurs. In particular, in a polyester, ester bonds are ruptured and lower molecules are generated. This formation of lower molecules is unsuitable from the standpoint of producing a high-strength porous body and becomes an obstacle. The second obstacle is that when high-temperature liquid alcohol in which PBT has been dissolved is rapidly cooled and solidified, the mixing degree of PBT and pentaerythritol in the solid body is at a molecular level and homogeneity thereof is high.

Where the mixing degree is at a molecular level, extracting and taking out only pentaerythritol molecules with water or ethanol becomes a difficult operation, and even if this operation is successful, air venting ability of the porous body obtained is expected to be degraded which is completely unacceptable from the standpoint of attaining the object of the present invention.

The present invention has been created against the above-described technical background by introducing various technical and theoretical improvements in order to attain the following objects.

It is an object of the present invention to provide a porous structural body for a vent plug that is suitable for practical use in terms of both air permeability and resistance to water pressure.

It is another object of the present invention to provide a porous structural body for a vent plug that imposes a low environmental load in waste treatment after use.

It is still another object of the present invention to provide a porous structural body for a vent plug that can be molded by injection molding that has high productivity.

### SUMMARY OF THE INVENTION

The present invention uses the following means to attain the above-described objects.

In a porous structural body for a vent plug according to the first aspect of the present invention, a cross section of the porous structural body has an overall structure entirely occupied by a structure composed of an infinite number of spherical or ellipsoidal cavities having a diameter of 1 μm to 100 μm, when observed under an electron microscope, and the structural body is of a continuous bubble type in which one or more holes are open in walls of each of the cavities and the cavity is linked to another cavity by the holes.

In a porous structural body for a vent plug according to the second aspect of the present invention, the inside of the porous structural body having spherical or ellipsoidal cavities dispersed therein is constituted by communicating open passages that pass in a meandering fashion between an outlet and an inlet of the porous structural body and are composed of a plurality of the cavities that are joined with each other in a chain configuration, and chain closed passages that are composed of one cavity or a plurality of the cavities and connected to the communicating open passages, and some or all of the cavities communicate with other cavities by a volume equal to or less than half of the volume of the cavity.

The porous structural body according to the third aspect of the present invention is the porous structural body according to the second aspect of the present invention, wherein equal to or less than 50% of all the cavities inside the porous structural body constitute the communicating open passages and the chain closed passages connected to the communicating open passages.

In the porous structural body for a vent plug according to any one of the first to third aspects of the invention, 50 to 60% of the cavities per unit cube may be the cavities having a diameter less than 10 μm. In this porous structural body for a vent plug, 35 to 45% of the cavities per unit cube may be the cavities having a diameter of 11 to 30 μm.

Alternatively, in this porous structural body for a vent plug, 5 to 15% of the cavities per unit cube may be the cavities having a diameter of 31 to 100 μm.

In the porous structural body for a vent plug according to any one of the first to third aspects of the invention, the cavity may be a continuous passage constituted by a first cavity with an effective diameter A and a second cavity with an effective diameter B that is less than the effective diameter A, and the first cavity may be determined by the number P of groups and number Q of elements within a region between

Q=−P+N

and

Q=N·exp(−P).

The porous structural body for a vent plug according to any one of the first to third aspects of the invention is manufactured by producing a molded article composed of 60 to 85 parts by weight of pentaerythritol, 15 to 40 parts by weight of a polybutylene terephthalate resin, and 0.25 to 3 parts by weight of at least one species selected from a polyfunctional alcohol that is liquid at normal temperature, polyethylene glycol, and polypropylene glycol, and immersing the molded article into water, thereby dissolving in water and removing water-soluble components contained in the molded article, to form a porous body having gas permeability in the molded article.

In the manufacture of the porous structural body for a vent plug, in order to increase water resistance, the molded article after immersion into water is immersed into a benzine solution of a methyl silicone polymer and then dried, thereby causing the methyl silicon polymer to adhere to a surface of the porous body and to an internal wall of a hole inside the porous body.

The present invention will be described below in greater detail. The difficulty of obtaining a PBT molded body with high air permeability by using pentaerythritol was such as predicted by the inventors, as described hereinabove. Thus, PBT was found to dissolve in the commercial pentaerythritol melted at a temperature equal to or higher than 200° C. When the dissolution product was allowed to stay at this temperature, PBT was alcoholyzed and molecular weight rapidly decreased. The conversion of PBT into lower molecules was inhibited by shortening the time interval from dissolution of PBT in pentaerythritol to rapid cooling, but the product thus obtained had low venting ability, that is, air permeability as suggested hereinabove.

However, by using an error and trial method the inventors have found that the addition of a specific third component is effective in terms of resolving this problem. Further, the microstructure of the finally obtained porous body has been analyzed and a steric structure having an orderly arrangement that makes it possible to obtain target properties and has apparently not been obtained in the past has been confirmed. This steric structure is suitable for imparting water repellency by using methyl silicone polymers and unexpectedly effective for obtaining a vent plug with a high resistance to water pressure. Why such an orderly arranged steric structure could be obtained was also examined, and satisfactory explanation has been given to the role of the third component other than pentaerythritol and PBT and limitations thereof. These findings will be successively explained below.

### [Specific Manufacturing Method and Starting Materials]

Starting materials for the porous structural body for a vent plug in accordance with the present invention and a manufacturing method therefor will be described below.

### [Pentaerythritol]

A generally available commercial product, rather than a special product, can be used as pentaerythritol to be used for the manufacture of the porous structural body for a vent plug in accordance with the present invention. Thus, a commercial product that contains about 10% dimers and an extremely small amount of trimers is pentaerythritol that is referred to hereinbelow in the description of the present invention. This pentaerythritol has a melting point of about 190° C. Such commercial product is generally in the form of a powder and is a classified product with a clearly stated average particle size and the like. However, pentaerythritol used in accordance with the present invention can be of any shape and particle size.

### [PBT]

PBT used as a starting material for the porous structural body for a vent plug in accordance with the present invention is generally used under an assumption that PBT alone, that is, without a filler, is employed, but a PBT composition including glass fibers or an inorganic powder filler can be also used. PBT used as a starting material can be used in the form of pellets or powder, and when a compound is actually produced, the handling method somewhat differs depending on the shape thereof.

### [Preparation of Mixture]

The three elements, namely, a pentaerythritol powder, PBT pellets or powder, and a third component are mixed in a mixer such as a tumbler or Henschel mixer. The coarse mixture thus obtained serves as a starting material for charging into an extruder. The mixing ratio is pentaerythritol 60 to 85 parts by weight, PBT 15 to 40 parts by weight, and at least one component selected from liquid polyfunctional alcohols, polyethylene glycol, and polypropylene glycol 0.25 to 3.00 parts by weight.

Where the amount of pentaerythritol is above the aforementioned mixing ratio, when PBT is considered as a reference base, the injection molded article becomes brittle and the injection molding itself is difficult. For example, the product is damaged or easily cracked when taken out of the mold in the injection molding process, or a runner is difficult to release during the injection molding. When the amount of pentaerythritol is less than the aforementioned mixing ratio, air permeance of the final product decreases. Examples of liquid polyfunctional alcohols include ethylene glycol, diethylene glycol, propylene glycol, glycerin, and glycerin dimers.

When the third component such as a liquid polyfunctional alcohol, polyethylene glycol, and polypropylene glycol is contained at a ratio above the aforementioned mixing ratio, the final product has a low mechanical strength. Conversely, when the third component is contained at a ratio below the aforementioned mixing ratio, air permeability of the final product is greatly reduced.

### [Fabrication of Pellets for Injection Molding]

In the fabrication of pellets, the coarse mixture obtained in the preceding process is charged as a starting material into an extruder, cooled, cut and pelletized. When the extruder is a twin-screw extruder, it is preferred that PBT as a starting material be in the form of a powder rather than pellets.

When pellets are used for the starting material, the balance thereof is difficult if not impossible to attain. This is because the probability of the already melted PBT to be converted into lower molecules increases as the pelletized PBT (referred to hereinbelow as “PBT pellets”) is being melted. Even if a certain amount of PBT is not melted and remains in the extrudate in the form of fine particles, actual damage produced thereby is small. Thus, it does not mean that pellets cannot be used as a starting material. The drawback of using PBT pellets is that it creates an obstacle for stable production of articles for practical use. The cylinder temperature of the extruder is preferably set to 225 to 230° C., regardless of the type of the extruder used.

A large number of tests actually conducted by the inventors of the present invention demonstrates the following two results: PBT can be easily dissolved in high-temperature liquid pentaerythritol and the rate of alcoholysis of PBT that proceeds simultaneously is unexpectedly high. Therefore, among the conditions under which the melted material is discharged from the nozzle, it is preferred that the material passage time in the extruder be the shortest and kneading be small. Thus, the screw rotation speed may be lower than the usually used rotation speed. A machine with a small L/D is suitable as the extruder. It is preferred that the melt discharged from the extruder be air cooled on a belt conveyor and the noodle-shaped product obtained be cut in a pelletizer.

### [Injection Molding]

The porous structural body for a vent plug in accordance with the present invention is molded by injection molding. The injection molding will be described below. The injection molding is used to mold the PBT pellets obtained in the above-described process, as a starting material, to a desired shape. The preferred injection temperature in this case is 220 to 230° C. It goes without saying that molding can be also performed by a molding method other than injection molding, but the injection molding is suitable for supplying products at a low cost. When the injection molding method is selected, the process is generally similar to that of the usual injection molding. The mold temperature is preferably 40 to 80° C. and the injection pressure is not different from that used with typical PBT. The molded article thus obtained has a lower amount of polymer component and therefore a lower molding shrinkage ratio and higher brittleness than the molded article of a typical PBT material.

As a consequence, when the mold is produced, the mold should be designed with consideration for properties different from those of other resins, such as molding shrinkage ratio. Thus, the draft gradient in a runner, spray, and the like should be increased and the tip surface area of an ejector pin should be increased to separate the molded article smoothly from the mold.

### [Bath Extraction Process]

A bath extraction process is a process of extracting pentaerythritol that is conducted with the object of obtaining a porous molded body. More specifically, the molded article is immersed in hot water at a temperature of 60 to 100° C., water-soluble components such as pentaerythritol are dissolved in the hot water, and the remaining molded article is made porous. The extraction time and extraction method vary depending on the thickness of the molded article. The tests conducted by the inventors of the present invention demonstrated that extraction at a ratio of equal to or higher than 99% could be performed within 6 to 10 h at a bath temperature of 75° C. by a cross-flow extraction method when the maximum thickness is about 3 mm. The final product in the form of a porous body has been obtained by placing the molded article after extraction for 1 h in a hot-blow drier at a temperature of 80-90° C.

### [Porous Molded Article]

An air permeance of the obtained porous article was measured. In the measurements, the air permeance is represented by a Gurley value stipulated by JIS (Japanese Industrial Standard) P8117. The Gurley value is the number of seconds required for 100 cc of air to pass through a round area with a diameter of 28.6 mm (6.42 cm²) under a gage pressure of 0.013 (in the definition, the pressure is applied by a mass of 567 g to 43 cm²). The air permeance varies mainly depending on the amount added of the third component, and the air permeance increases and a physical strength decreases at the same time as the amount added increases.

Where the amount added is decreased, the trend is reversed. In terms of the Gurley value, when the thickness is 3 mm, the control can be performed within a range of from several seconds to a hundred and several tens of seconds. Essentially, any structural portion, provided it is porous, can be used as an inexpensive vent plug. Thus, the structure shown by way of example in FIG. 1 has a round shape, a thick circumference, and high resistance to compression. In this structural body, the central portion is thin and air permeance is high. The circumferential portion of the porous structural portion is tightened for fixing with a male screw having an open hole. Therefore, the peripheral portion is required to be strong enough not to break under pressure. PBT is a polymer harder than PP or the like and has a certain strength even in a porous state, but it is preferably used in a state in which appropriate physical strength is maintained, without excessively increasing the air permeance.

### [Structure and Performance of Porous Body]

When the surface of the porous body was observed under an electron microscope, a very large number of openings with a diameter of 0.5 to 10 μm were observed, and the surface ratio thereof was observed to take 5 to 30% the total surface area. A porous body produced from a compound containing 1 wt. % glycerin as a third component and 30 wt. % PBT has high air permeance, the Gurley value in a plate-shaped material with a thickness of about 3 mm being 5 to 10 sec, but the resistance to water pressure is as low as about 0.5 m. Judging by these numerical values, it was made clear that continuous cavities through which both air and water can effectively permeate has been obtained, but since only open portions were seen from the surface, the presence of communicating portions has not been established.

### [Structure of Communicating Portions of Porous Body]

The inventors of the present invention represent the present invention as relating to a porous body, but the shape thereof can be said to be that of a foamed structural body. Foamed structural bodies can be of an isolated bubble type and a continuous bubble type, and the product produced in accordance with the present invention is a structural body of the “continuous bubble type”. General information relating to foamed structural bodies will be described below since it is necessary for explaining the structure in accordance with the present invention. Thus, foamed polystyrene and foamed polyurethanes are industrial products that have been the objects of mass production for a long time, and most of these industrial products are of the isolated bubble type.

Rubber sponges that have been manufactured since ancient times are also of the isolated bubble type. Such foamed bodies are manufactured basically by the same method of mixing an LPG (liquefied petroleum gas) or a foaming agent with a polymer and then foaming by increasing temperature or reducing pressure and solidifying. Since a foamed body is difficult to produce if the holes are simply opened in the bubbles one by one, the production technology of products of the isolated bubble type became a basic technology and the market development has been advanced for such products. However, there are many markets in which the products of the continuous bubble type are desired, and the industrial products of the continuous bubble type have been produced by employing a variety of techniques. In the field of foamed resins, “when foamed products are immersed in water under specific conditions, those with a water absorption ratio of higher than 5% are considered to be of the continuous bubble type and those with a water absorption ratio of equal to or less than 5% are considered to be of the isolated bubble type (MIL-R6130C)”.

Therefore, more than half of isolated bubbles in most cases remain even in the foamed products that are considered to be continuous bubble products. Thus, basic methods for producing continuous bubble products have been developed 10 to 20 years ago and the history thereof is still short. These production methods can be generally classified into methods by which a continuous bubble product is obtained by modifying a compound recipe or changing treatment conditions (referred to hereinbelow as first manufacturing methods), methods by which a continuous bubble product is obtained by producing an isolated bubble product and then subjecting it to processing (referred to hereinbelow as second manufacturing methods), and other methods (referred to hereinbelow as third manufacturing methods).

The first manufacturing method uses various techniques, such as introducing a large amount of a foaming agent into a resin to facilitate the rupture of bubble walls, making the resin hard and brittle to facilitate the rupture of bubble walls, and introducing an inorganic filler so that holes can be easily opened in the walls during foaming. In the second manufacturing method, the known methods include a method by which a foamed plastic sheet of an isolated bubble type that has been produced is irradiated with electromagnetic waves such as microwaves and thin sections of bubble walls are melted by the generated heat, a method by which the foamed plastic sheet is passed between rolls provided with a very large number of needles to form the holes physically, and a method by which the foamed plastic sheet is nipped between two rolls to apply pressure and crush the bubble walls, including the internal portions thereof.

The porous structural body developed by the inventors of the present invention is a structural body of the continuous bubble type, and the manufacturing method thereof is the third manufacturing method, but this structural body significantly differs from those obtained by the first manufacturing method and the second manufacturing method in the structure thereof, rather than only in the manufacturing method. Thus, uniformity of the foamed structure will be considered. The articles manufactured by the first manufacturing methods and the second manufacturing methods are essentially obtained by using an article obtained by a process designed for producing isolated bubble products and then subjecting the article to deformation or additional processing. However, the process history remains in the product. Thus, regardless of whether the product is obtained by molding in a mold or extrusion, the detailed physical properties differ between a surface layer portion and an internal phase.

For example, the difference in physical properties between the so-called skin layer and the internal phase (a bubble wall thickness in the surface layer portion is larger than that in the internal phase, and the bubbles in the surface layer portion are generally smaller than those in the internal phase) is also present in the foamed product. The skin layer effect discovered by the inventors can be confirmed by cutting out a foamed structural body in the form of a curve with a 3 mm side and studying the physical properties thereof. In a structural body of a continuous bubble type fabricated by a foaming method based on the first manufacturing methods and second manufacturing methods, the physical properties of the 3-mm curve taken from the skin layer have to be somewhat different, for all measured properties, from those of the 3-mm cube cut out from the internal phase. Even when checked by this method, the porous structural body in accordance with the present invention demonstrates no difference between the skin layer and the internal portion.

Visual observations are a rather crude method, but the picture is clear even when the photographs shown in the below-described FIGS. 4 to 9 are visually observed. Thus, no difference in terms of size and size distribution of bubbles can be found between the surface layer portion and the internal phase. The inventors of the present invention think that the greatest feature of the present invention is in the foamed structure in which the surface layer portion and the internal phase portion basically do not differ from each other. As far as it is known to the inventors, such a foamed structure has not been obtained by the conventional methods for producing foamed molded articles. Speculating on the reasons therefor, as long as the resin melt is solidified by cooling in a die or a guide mold, physical properties identical to those of the internal phase apparently can be never obtained in the vicinity of the surface layer where the cooling and solidification are started. It can thus be said that the porous structural body in accordance with the present invention is abnormal when compared with the conventional foamed products. The reasons for such an abnormality will be considered below.

### [Operation of Imparting Water Repellency]

As described above, a process of imparting water repellency is necessary to obtain a porous body with suppressed permeability to water droplets and high resistance to water pressure, while maintaining high air permeance. Based on general knowledge in the field of chemical technology, the following three methods have been successively tested. (1) A method by which a porous body is soaked into a PTFE emulsion, which is an intermediate product in the manufacturing of PTFE, and dried to attach fixedly small-diameter PTFE particles inside the porous body, (2) a method by which a polymer soluble in a solvent having a large number of perfluoroalkyl groups is acquired, an organic solvent solution thereof is prepared, the porous body is immersed there to cause adsorption and then dried, and (3) a method by which the porous body is immersed in a benzine solution of a methyl silicon polymer to cause adsorption, the solvent is evaporated, and then the porous body is fired at a high temperature, thereby creating a forest of methyl groups and increasing water repellency (Japanese Patent Applications Laid-open No. 2008-7534) and also advancing a bonding reaction between the end groups of the silicone polymer, increasing the molecular weight, and fixing the polymer inside the venting cavities.

As described hereinabove, the present invention uses the first manufacturing method and does not use a fluoropolymer as the above-described methods (1) and (2), but from the standpoint of a general concept of obtaining a high-performance vent plug, all the methods obviously should be tested. However, apparently due to incredible luck, the methods (2) and (3) are superior both theoretically and in terms of performance. The method (3) scored the highest grade since it created absolutely no environmental problems. The performance thereof will be described in greater detail below. First, it was established that the method (1) is hardly suitable. Thus, the inventors have immediately understood that impregnating a porous body with an emulsion obtained as an intermediate product from the manufacturer is not a good approach.

Particles of the emulsion demonstrated significant cohesion and the particle size was too large for the emulsion to penetrate into the porous body. For this reason, an attempt was made to crush the particles in liquid by using a homogenizer, but cohesion took place again after the emulsion was allowed to stay for a long time after the processing, and therefore this method was judged to be unsuitable for actual production. With the method (2), very good performance was demonstrated. An acrylic polymer with attached perfluoroalkyl groups that has been used was developed by a certain company as a polymer with good solubility in organic solvents. This polymer demonstrated excellent performance in terms of imparting water repellency in accordance with the present invention and also excelled in stability of resistance to water pressure. However, air permeance of the acrylic polymer dropped abruptly when the adsorbed amount increased.

More specifically, a solution obtained by dissolving in an organic solvent to a low concentration of about 0.05 to 0.2 wt. % was effective in imparting water repellency, and the air permeance was good and at the same level as before the application of the water repelling agent. However, in a solution in which the concentration of the water repelling agent exceeded 1 wt. %, air permeance clearly decreases when a final product was obtained by immersing the above-described porous body, and when the porous body was immersed in a solution with a high concentration of equal to or higher than 2 wt. %, the porous body became air impermeable. This is apparently because fine transparent gen has been present in the organic solvent solution of the water repelling material. It goes without saying that when the process is conducted without errors in concentration adjustment, absolutely no problem is associated with the performance.

When the solution is repeatedly used, the organic solvent is easily evaporated. In mass production, the concentration should be measured at all times, and it is possible that a control error will produce a significant hindrance. By contrast, with the above-described method (3), no such pattern is observed in the relationship between the concentration of the water repelling agent solution and the air permeance of the final product. This is because water repellency of the final product could be increased by conducting firing for about 1 h at a temperature of 150° C. after adsorption. The temperature of 150° C. is within a range that is not detrimental at all for PBT products, and from this standpoint the selection of PBT, which has high heat resistance, as a substrate material for the porous body is also effective. Thus, the above-described methods (1) to (3) were tested and the method (3) was selected, this selection being also made with consideration for environmental friendliness of this method.

### [Structural Issues: Microstructure of the Product According to the Invention: High Uniformity]

FIGS. 4 to 9 show cross-sectional photos of the porous structural body which is a product in accordance with the present invention. A total of six disk-shaped porous bodies, which are porous materials before being subjected to the process of imparting water repellency, with a thickness of 3 mm that are produced from a compound including 70 parts by weight of pentaerythritol, 30 parts by weight of PBT, and 1 part by weight of glycerin are used as samples. Each disk-shaped material is cut and the cross-sectional surface is photographed under an electron microscope. Although there is a certain difference in size of the bubbles between the products, from the standpoint of a variety of data obtained, the bubbles are spread over the entire surface, the spread in size thereof is small, and uniformity of the foamed structure is high.

It is especially noteworthy that there is no significant variations in size and size distribution of bubbles in the upper and lower surface portions and the internal phase portion. Further, as can be seen in the photographs with largest magnification in FIGS. 4 to 9, holes can be clearly observed in the walls of large bubbles facing the surface. These bubbles communicate with other bubbles via these holes. These holes are clearly the passages for linking the bubbles to each other and represent through holes. The number of these linking paths (the average number of linking paths that are open in one bubble) and whether or not there is a regularity in the orientations of the linking paths are the most important factors in checking a microstructure, but the conclusion cannot be made based only on the photographs. Meanwhile, there was a feeling that the process speed at which pentaerythritol or the like is extracted with a hot bath from a molded article of the compound is rather high in actual operations.

Thus, in the case of a disk-shaped material with a thickness of 3 mm and a diameter of 54 mm, the extraction ratio of about 90% was attained in a shortest time of 2 h at a water temperature of 70° C. When the bath was replaced with a new material and again allowed to stay for 2 h at a water temperature of 70° C., the extraction ratio exceeded 98%. When the bath was replaced again and allowed to stay for 3 h, the extraction could be performed at a ratio of equal to or higher than 99.5%. Such an extraction speed cannot be explained unless the linking paths are connected in the longitudinal and transverse directions. This is because, when no third component was contained and the Gurley value in the final product exceeded several hundreds, a week was required, even with the bath at a temperature of 70° C., to obtain an extraction ratio of equal to or higher than 98%.

Concerning the aforementioned number of holes open in the bubble walls, that is, the number of linking paths per one bubble, and the regularity in the linking path orientation, the inventors of the present invention have discovered a method for verifying the latter. Thus, a thick disk-shaped material with a thickness of 5 mm and a diameter of 46 mm was obtained as a vent plug with a remodeled die. This material was subjected to hot-bath extrusion to obtain a porous body, the central portion of this thick disk-shaped material was cut in the longitudinal direction, and a plate-shaped article with a thickness of 3 mm, that is, a porous plate in the form of a rectangular parallelepiped with a width of 5 mm, a length of 40 mm, and a thickness of 3 mm was obtained. The air permeance thereof was measured. The test was conducted by using five samples, and the Gurley values of all of the samples was found to fit into a numerical value range of the initial plate material with a thickness of 3 mm.

Thus, gas permeability is the same, regardless of the molded article shape and direction in which the gas is caused to permeate, provided that the initial compound is the same. It means that in the article in accordance with the present invention, there is no regularity in the orientation of linking paths and they are present with a similar probability in the vertical, horizontal, and oblique directions.

### [Structural Issues: Microstructure of the Product According to the Invention: Water Repellency]

A mechanism by which the article in accordance with the present invention gains the resistance to water pressure will be described below with reference to FIG. 4. Thus, a case is considered in which a methyl silicone polymer is adhered by and fixed to a porous body, as described hereinabove. In this case, the size of linking paths is more important that the bubble diameter for realizing the resistance to water pressure.

In a case in which a water repelling agent is assumed to be fixed over the entire surface and water is introduced from one side surface of a plate-shaped vent plug and caused to pass through to the opposite side, it is the linking paths (through holes) present between the bubbles that create obstacles for the passage. Where a water repelling agent is fixedly attached to the linking paths, water droplets of water flow will be able to pass through only in all the central portions of the linking paths. Moreover, when the linking paths are fine, water repellency is effective even in the centers of linking paths, and water droplets will be unable to pass through, unless they have a sufficient kinetic energy. When a pressure is applied to the end of a water flow, a pressure loss is generated when the flow passes through the linking paths. The accumulated pressure loss is a resistance to water pressure.

When the resistance to water pressure is overcome and water advances to the opposite surface, it is clear that water oozes to the opposite surface after filling all of the bubbles and linking paths through which the water passes. In other words, it is clear that the vent plug in accordance with the present invention can completely block the permeation of water droplets in the usual applications.

### [Why Uniform Structure is Obtained: Theoretic Consideration]

A porous body obtained by completely melting a mixture of commercial pentaerythritol and PBT at a temperature of 190 to 225° C. (that is, dissolving the polymeric PBT in the melted pentaerythritol) and then immediately cooling, using the solidified material as a starting material, injection molding, and extracting pentaerythritol from the molded article to an extraction ratio of about 99% within a period of equal to or longer than 1 week, while replacing the bath, has a Gurley value of several hundreds of seconds and low air permeance and cannot us used as a vent plug.

This is because the uniformity of mixing is too high. This has also been expected to occur before the research and development conducted in relation to the present invention. Accordingly, changes that could be induced by the addition of a very small amount of a polyfunctional alcohol that is a liquid at normal temperature, such as glycerin, to the starting material for injection molding have been considered. When a liquid including melted pentaerythritol, PBT, and glycerin is cooled and starts solidifying, it is the PBT that is first to precipitate. It seems to be rather unnatural if PBT dissolves in molten pentaerythritol and dissolution continuous in a temperature range in which the solvent itself solidifies.

Where this reasoning is correct, when solidification starts, the PBT molecules become the crystallization nuclei and pentaerythritol seems to crystallize around them. Where this process advances as is, a uniformly mixed solid body is obtained and no role is played by glycerin. However, pentaerythritol that solidifies with a delay (separates from the PBT molecules) due to the co-presence of glycerin, although in a small amount, joins the glycerin and the glycerin is concentrated by the portion of pentaerythritol separated from the PBT. As a result, solidification of pentaerythritol is further delayed and it can be assumed that when the entire body approaches a state of solidification, a steric mutual arrangement is produced that is similar to a pool in which PBT is a surrounding area, the circumference of the pool solidified, but the center of the pool is a pentaerythritol portion with a high concentration of glycerin.

In this consideration, pentaerythritol dimers were ignored, but from the standpoint of pentaerythritol, the dimers are a foreign matter present in a small amount and therefore apparently should be pushed similarly to glycerin to the center of the pool. Essentially, the reasoning is that a foamed structure is automatically formed due to the presence of a small amount of the third component and cooling of the melt. The correctness of this idea can be also confirmed by the fact that no skin layer effect is demonstrated, as mentioned hereinabove, although the molded article is obtained and also by high uniformity of the final product. Where an adequate amount of glycerin is added, a basic foamed structure shown in FIGS. 4 to 8 is produced when the melt is cooled and a dam of the pool where the PBT molecules are concentrated is absent, that is, the wall portions are not present in an amount sufficient to cover completely the central portion of the pool, and this portion eventually becomes a through hole, that is, a linking path.

It was thought that a very large number of bubble cells have appeared as a result of physical operations such as simple dissolution and subsequent cooling and solidification of the solution and that slight defects occurring in this process produce linking paths between the bubbles. Where the process taking place when no third component such as glycerin is present is analyzed again based on the above-described approach, it can be assumed that solidification actually does not proceed without disruption of uniformity, and pentaerythritol dimers, which are impurities from the standpoint of pentaerythritol molecules, apparently play the same role as glycerin. It was thus supposed that since the molecular structure closely resembles that of pentaerythritol, the effect as clear as that of glycerin was not demonstrated, the bubble diameter decreased and the formation of linking paths was thereby hindered.

[Operation of the Porous Structural Body in Accordance with the Present Invention]

Where the porous structural body in accordance with the present invention is used in air passages of sealed containers that should be protected from penetration of dust or water, such as containers of light-emitting bodies, electron circuits, relay circuits, motors, and other drive components, or placed inside the sealed members, the internal pressure variations occur due to variations in ambient temperature or own heat generation. When the internal pressure variations are severe or cyclic variations continue, the sealed containers themselves are fractured. Components produced from the porous structural body in accordance with the present invention can be mounted as vent plugs on these sealed containers to prevent such a fracture.

The present invention demonstrates the following effect. The present invention makes it possible to provide a porous structural body for a vent plug having a uniform structure in the surface and inside. With the porous molded article using the air-permeable porous structural body in accordance with the present invention, an inexpensive heat resistance vent plug can be provided.

### BRIEF DESCRIPTION OF THE DRAWINGS

FIG. 1 shows an external appearance view of a porous molded body used for a vent plug;

FIG. 2 is a cross-sectional view of a vent plug fixing structure illustrating a state in which the porous component shown in FIG. 1 is assembled;

FIG. 3 is a schematic drawing illustrating the direction of photographing when a sample is observed;

FIG. 4 is a photo illustrating the SEM observation results relating to a first sample;

FIG. 5 is a photo illustrating the SEM observation results relating to a second sample;

FIG. 6 is a photo illustrating the SEM observation results relating to a third sample;

FIG. 7 is a photo illustrating the SEM observation results relating to a fourth sample;

FIG. 8 is a photo illustrating the SEM observation results relating to a fifth sample;

FIG. 9 is a photo illustrating the SEM observation results relating to a sixth sample;

FIG. 10 is a photo illustrating the observation results obtained for the first sample with X ray CT;

FIG. 11 is a photo illustrating the observation results obtained for the second sample with X ray CT;

FIG. 12 is a photo illustrating the observation results obtained for the third sample with X ray CT;

FIG. 13 is a graph illustrating image analysis results obtained for the first to third samples;

FIG. 14 shows how the trend in the graph shown in FIG. 13 is patterned to analyze the examples;

FIG. 15 is a graph illustrating formulas Eq. 2 to 4;

FIGS. 16A-F represents schematically a cavity of each element constituting the internal structure of the porous structural body;

FIG. 17 represents schematically the internal structure of the porous structural body;

FIGS. 18A-C represents schematically how a fluid passes through a communication path composed of two cavities;

FIG. 19 shows a state in which a fluid flows in the communication path connected to a non-communication path;

FIG. 20 shows an example in which a fluid flows in a communication path of the porous structural body, and

FIG. 21 shows schematically the structure of a sponge.

### DESCRIPTION OF THE PREFERRED EMBODIMENTS

The embodiments of the present invention will be explained below by examples thereof. Examples of manufacturing the aforementioned porous molded article will be described below in greater detail.

### Examples

### Example 1

### [Fabrication of Porous Body]

Commercial PBT (Trecon 140, manufactured by Toray Industries, Inc. (Japan, Tokyo)) was crushed in a crusher for resins (Turbo Disk Mill TD-150, manufactured by Matsubo KK (Japan, Tokyo)), the crushed material was classified with a 20-mesh shifter, and the powder side was recovered and used as a PBT starting material. Commercial pentaerythritol (Pentaerythritol, manufactured by Mitsubishi Gas Chemical Co., Ltd. (Japan, Tokyo)) was used.

This pentaerythritol contained about 10% dimers. Glycerin (Glycerin, manufactured by Showa Chemical Industry Co., Ltd.)) was used. Then, 30 parts by weight of PBT, 69 parts by weight of pentaerythritol, and only 1 part by weight of glycerin were weighed and mixed thoroughly in a Henschel mixer. The mixture was high-speed extruded with an extruder (FS50-22, manufactured by Ikegami Iron Works)) at a temperature in the entire cylinder of 230° C. The extruded product was passed through cold water at a temperature of 5° C., high-speed solidified and then crushed in a pelletizer. The solidified body was hard but brittle and cutting in the pelletizer produced pellets with a powder admixed thereto. Such pellets were used as is.

The aforementioned extruded product was placed in a 60T-type injection molding machine (PS-60, manufactured by Nissei Jushi Kogyo KK (Japan, Nagano prefecture)), and 200 disk-shaped articles with a thickness of 2 mm and a diameter of 46 mm were injection molded at an injection temperature of 230° C. and a mold temperature of 50° C. Several disk-shaped articles were immersed into a bath with a capacity of 20 L at a temperature of 70° C. and allowed to stay therein for 24 h. For the initial 8 h, light stirring was conducted for about 1 min in each hour. Then the bath was replaced with a new bath with a temperature of 70° C. and the same operations were conducted over 8 h. Next day, the bath was again replaced and same operations were conducted. The article obtained was placed into a hot-air drier at a temperature of 90° C. and dried for 2 h. When an air permeance of the dried disk-shaped articles was measured, the Gurley value was within a range of 11 to 21 sec and the average value was 16.8 sec.

### Example 2

### [Solution of Water Repelling Agent]

A water-repelling solution (SR2406, manufactured by Toray-Dow Corning Co. (Japan, Tokyo)) in which a methyl silicone polymer compound was dissolved in toluene was purchased. The concentration of solid matter in the liquid was 50%. Solutions were then prepared by adding hexane (manufactured by Showa Chemical Industry Co., Ltd. (Japan, Tokyo)) to obtain a concentration of solid matter of 0.5%, 1%, 2%, and 5%. These water repelling agent solutions were denoted by “SR2406/0.5”, “SR2406/1”, “SR2406/2”, and “SR2406/5”.

### Example 3

### [Immersion, Drying, and Firing: Completion of Vent Plug Production]

The porous plate-shaped material produced in Example 1 was immersed for 1 h in the water repelling agent solution “SR2406/0.5” prepared in Example 2. The material was then taken out, placed on a stainless steel SUS304 mesh, allowed to stay for several tens of minutes in a draft, then placed together with the mesh into a hot-air dryer set to a temperature of 80° C., and dried for 1 h. The temperature was then set to 150° C. and the material was allowed to stay for 2 h after the temperature had been raised. The air permeance and resistance to water pressure of the obtained plate-shaped material were examined.

### Examples 4 to 6

### [Immersion, Drying, and Firing: Completion of Vent Plug Production]

The test was conducted in the same manner as in Example 3 by using the water repelling agent solution “SR2406/1” in Example 4, water repelling agent solution “SR2406/2” in Example 5, and water repelling agent solution “SR2406/5” in Example 6.

### Structure Example 1 of Porous Molded Article

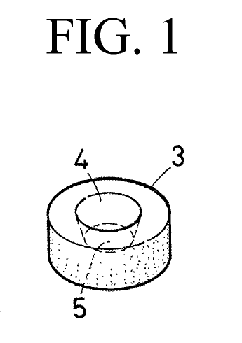

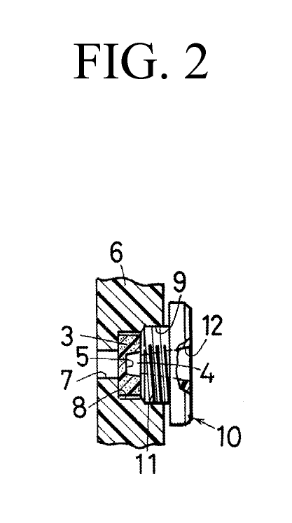

FIG. 1 is an external view of a porous molded article used for a vent plug. FIG. 2 is a cross-sectional view of a vent plug fixing structure illustrating a state in which the porous component shown in FIG. 1 is assembled. The porous molded body 3 shown in FIG. 1 has a cylindrical external appearance, and a conical orifice 4 is formed in the central portion thereof. The porous molded body 3 constitutes a component of a vent plug. This molded article as a whole is a porous body and represents an air permeable part. The bottom portion 5 of the orifice 4 has the smallest thickness and is therefore the main passage for air.

FIG. 2 is a cross-sectional view illustrating an example of a vent plug fixing structure using the porous molded body 3. A through hole 7 is formed in a wall 6 of a container that is required to be sealed. A large-diameter hole 8 is formed coaxially in the hole 7. An inner thread 9 is formed at the inner circumferential surface of the large-diameter hole 8. The porous molded article 3 is inserted and disposed at the bottom of the large-diameter hole 8. A fixing screw 10 is provided for fixing the porous molded article 3 to the bottom of the large-diameter hole 7. A male thread 11 is formed on the outer circumference of the fixing screw 10, and the porous molded article 3 if pressed against the bottom of the large-diameter hole 8 and fixed thereto by screwing the male thread 11 into the inner thread 9.

The outer circumference of the porous molded article 3 is required to have a strength sufficient to prevent the article from being compressed and broken by the applied pressure. A taper hole 12 is formed to pass the air through the center of the fixing screw 10. Therefore, the external air can pass between the inside and outside the container through the taper hole 11 of the fixing screw 10, orifice 4 of the porous molded article 3, and bottom portion 5 thereof. A simple pressurization test was conducted with respect to this structure in the following manner. The porous molded article 3 was inserted into the large-diameter hole 8, and the porous molded article 3 was prefixed inside the large-diameter hole 8 with the fixing screw 10. The prefixing position to which the fixing screw 10 is tightened is an angular position attained by turning the fixing screw 10 till it cannot be easily turned any longer.

The fixing screw 10 was then turned through 30 degrees from this prefixing position and tightened for final fixing. This tightening test was conducted with respect to 1300 parts obtained, and then all the assemblies were again disassembled and observed under a microscope. No cracks or the like were observed in the circumferential portion of the porous molded articles 3. The above-described fixed structure in which the porous molded article 3 is fixed to a wall surface 6 of a semi-sealed container was produced using thinner thread 9 and the fixing screw 10. However, this structure is not limiting, and a method of fixing during molding by using the porous molded article 3 when the semi-sealed container is molded, or a method using fixing means such as bonding with an adhesive or mechanical pressure fitting may be also used.

### [Measurement 1]

Air permeance and resistance to water pressure were measured with respect to vent plugs made from the porous bodies obtained in the examples. The air permeance (Gurley value) was measured using a Gurley Densometer (manufactured by Toyo Seiki KK (Japan Tokyo)). The resistance to water pressure was measured with a High-Pressure Water Resistance Tester (manufactured by Daiei Kagaku Seiki KK (Japan, Kyoto prefecture)). The results obtained in measuring the air permeance and resistance to water pressure of the porous bodies are shown in Table 1.

TABLE 1
Air Permeance and Resistance to Water Pressure of Vent Plug
Samples

| | | | Average Value | Average Value |
|---|---|---|---|---|
| | | | of Air | of Resistance |
| | | Water | Permeance | to Water |
| | Porous | Repelling | (Gurley | Pressure (water |
| Example | Body | Agent Used | value: sec) | column: m) |
| Example 3 | Example 1 | SR2406/0.5 | 11.5 | 1.1 |
| Example 4 | Example 1 | SR2406/1 | 10.5 | 1.3 |
| Example 5 | Example 1 | SR2406/2 | 11.3 | 2.4 |
| Example 6 | Example 1 | SR2406/5 | 13.0 | 3.5 |

[Measurement 2]

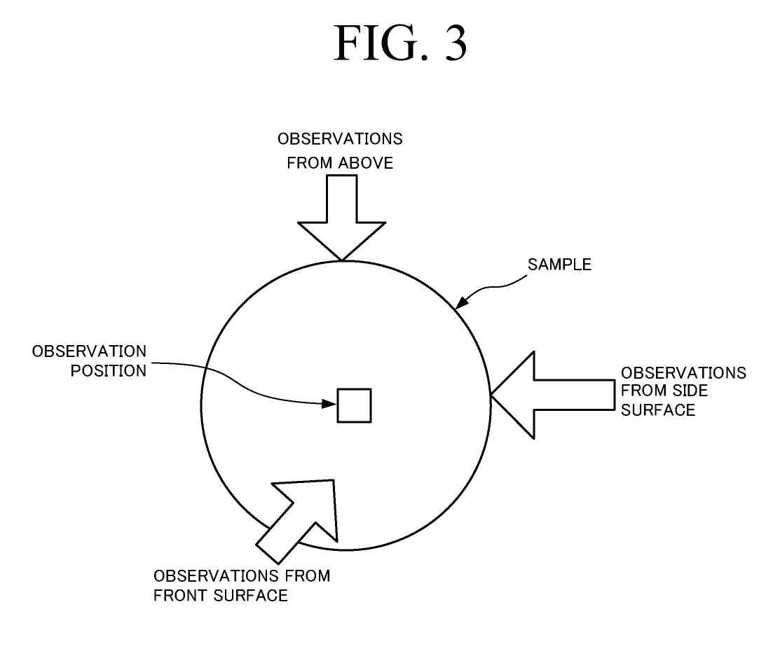

Measurement 2 is described below. Thus, the results obtained in observing the samples of the porous molded articles manufactured in Example 1 of the present invention are shown below. The samples were examined under a scanning electron microscope (SEM) and a three-dimensional X ray computer tomography (X ray CT). General information relating to the samples used for measurement 2 is shown in FIG. 3. As shown in Table 2, first to sixth samples were prepared. Columns in the table 2 indicate (form left to right) the sample, sample diameter, sample thickness, permeation time, figure relating to SEM observations, and figure relating to X ray CT observations.

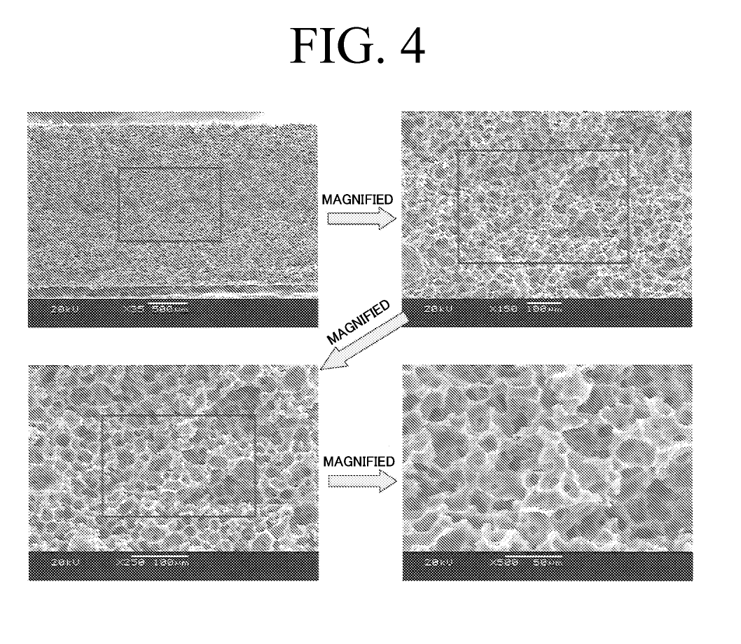

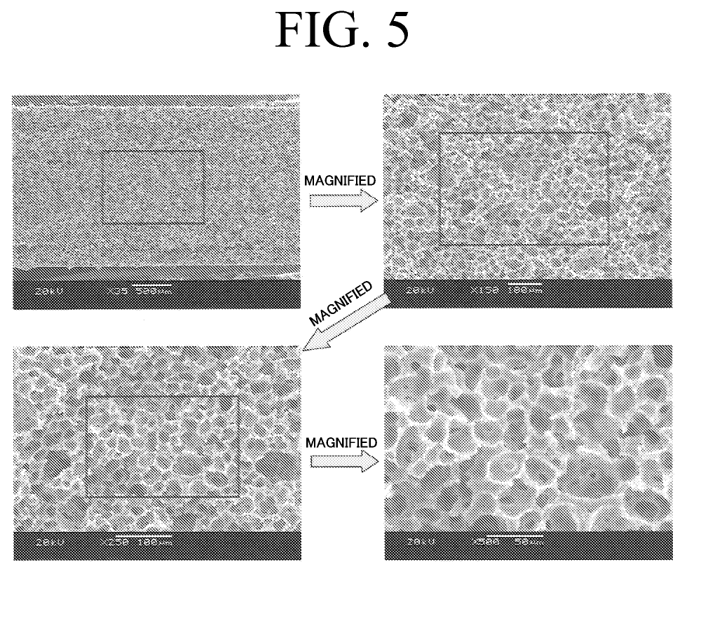

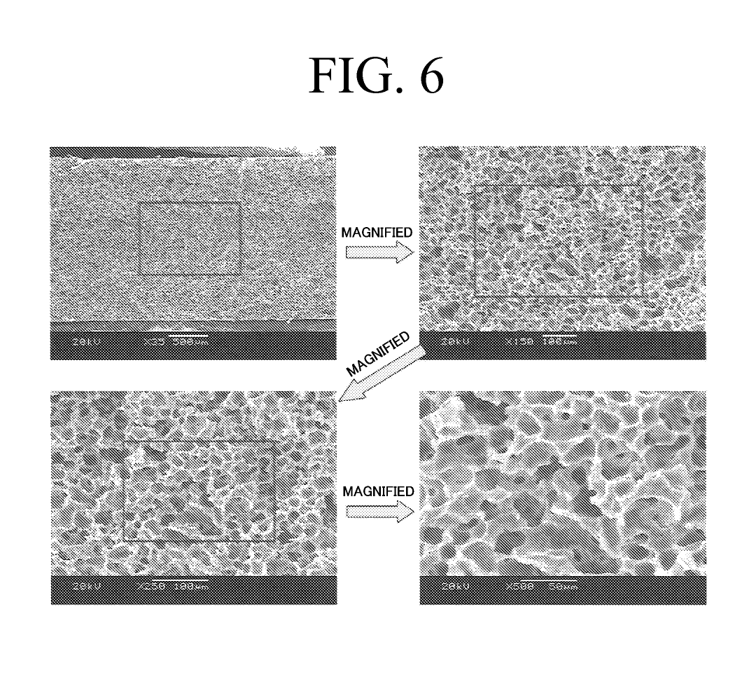

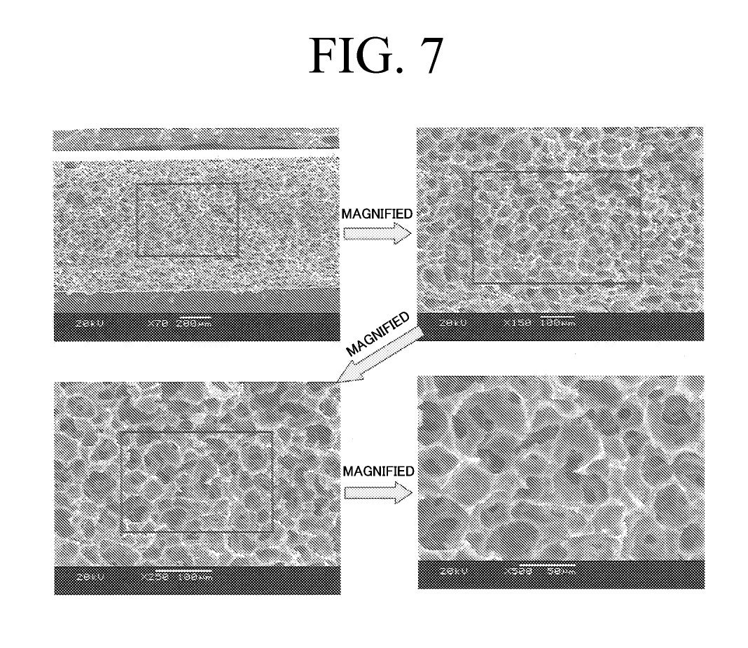

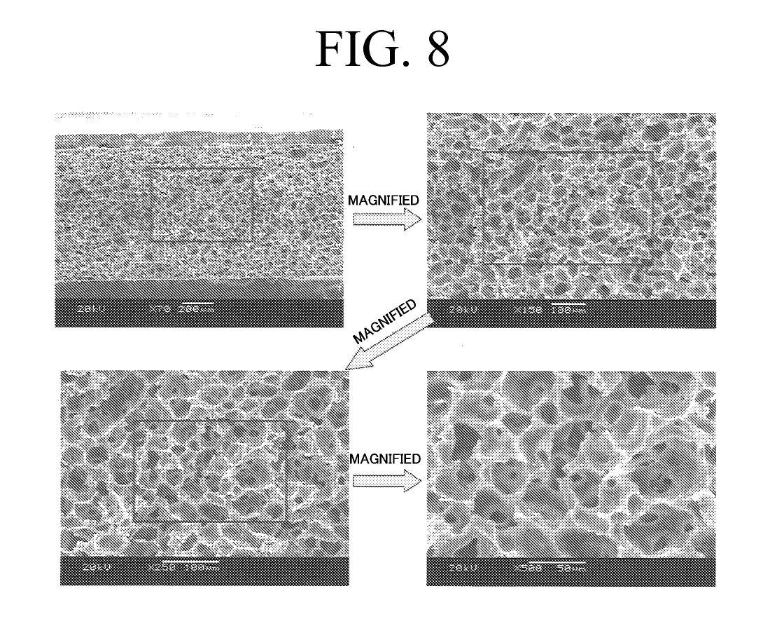

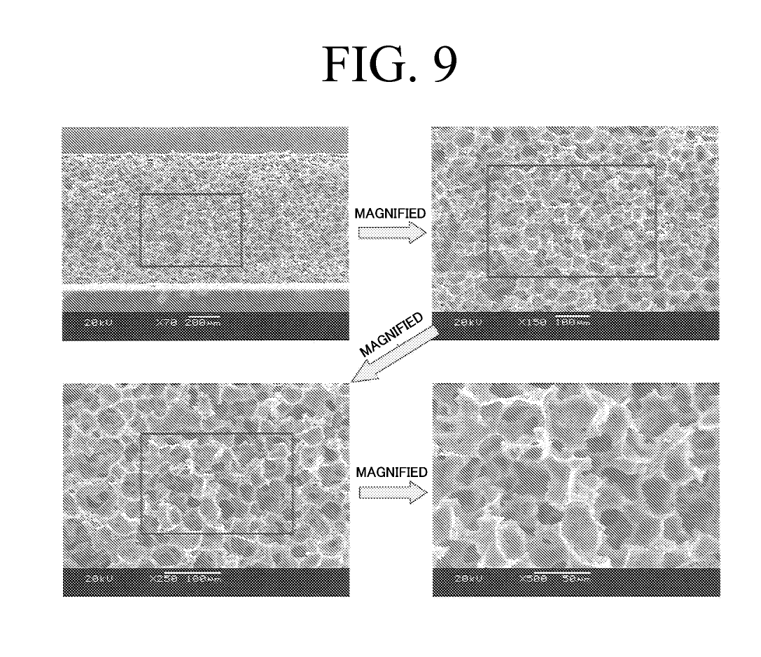

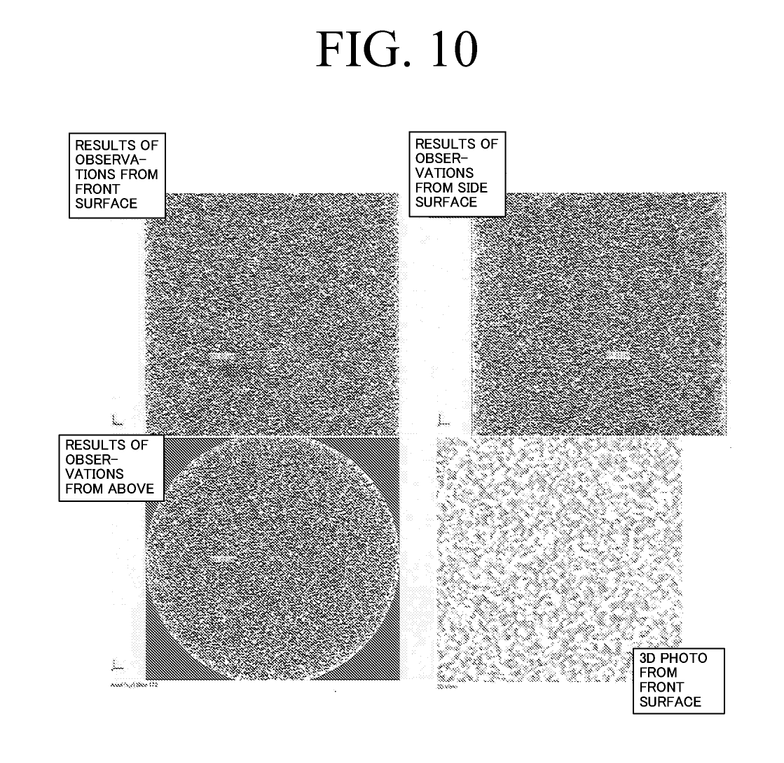

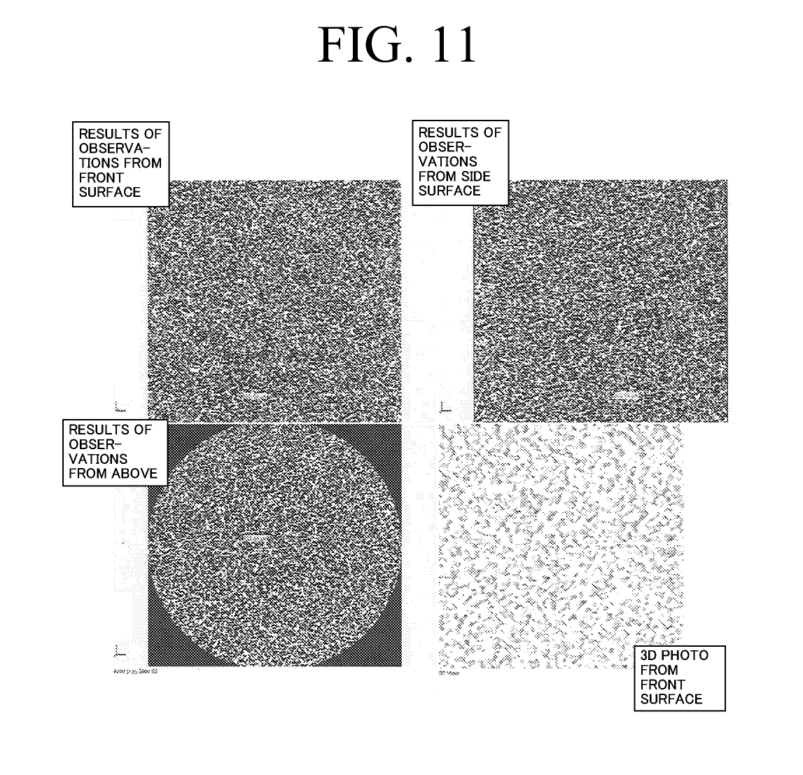

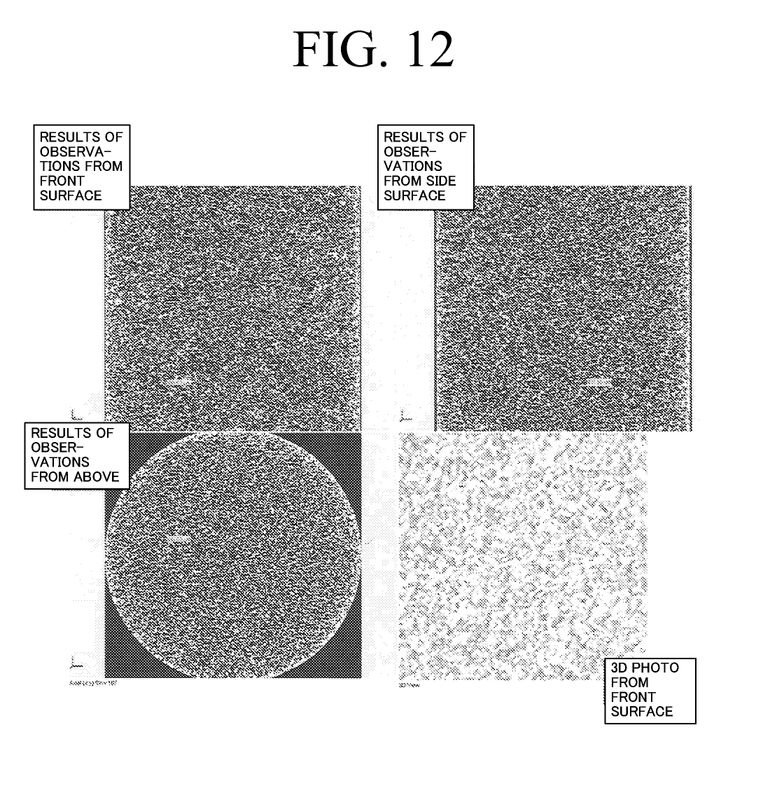

TABLE 2

| | Sample | Sample | Permeation | | | |
|---|---|---|---|---|---|---|
| Sample | Radius | Thickness | Time | | SEM | X ray CT |
| First | 7 cm | 2 mm | 6 | sec | FIG. 4 | FIG. 10 |
| Sample | | | | | | |
| Second | 7 cm | 2 mm | 8 to 10 | sec | FIG. 5 | FIG. 11 |
| Sample | | | | | | |
| Third | 7 cm | 2 mm | 22 | sec | FIG. 6 | FIG. 12 |
| Sample | | | | | | |
| Fourth | 4.5 cm | 0.8 mm | 13.2 | sec | FIG. 7 | |
| Sample | | | | | | |
| Fifth | 4.5 cm | 0.8 mm | 26.7 | sec | FIG. 8 | |
| Sample | | | | | | |
| Sixth | 4.5 cm | 0.8 mm | 36.8 | sec | FIG. 9 | |
| Sample | | | | | | |

FIGS. 4 to 9 are photos illustrating SEM observation results obtained for the first to sixth samples. The photos in FIGS. 4 to 9 show the sample with successive magnification. For example, four photos are shown in FIG. 4. The upper left photo in the figure is that of the first sample. The upper right photo in the figure is obtained by magnifying a portion represented by a rectangle in the upper left photo in the figure. Likewise, the lower left photo in the figure is obtained by magnifying a portion represented by a rectangle in the upper right photo in the figure. The lower right photo in the figure is obtained by magnifying a portion represented by a rectangle in the lower left photo in the figure.

FIGS. 10 to 12 are photos illustrating observation results obtained for the first to third samples by X ray CT. Each of FIGS. 10 to 12 includes four photos. These photos represent transitions between the observation angles of the samples. The observation direction of the sample is shown by arrows displayed in FIG. 3. Thus, there are three directions: from above, from the side surface, and from the front surface. The front surface direction is perpendicular to those from above and the side surface and perpendicular to the sheet surface, when referred to FIG. 3. Black portions seen in FIGS. 10 to 12 are cavities. Judging by FIGS. 4 to 9, cavities of various sizes can be seen in the samples.

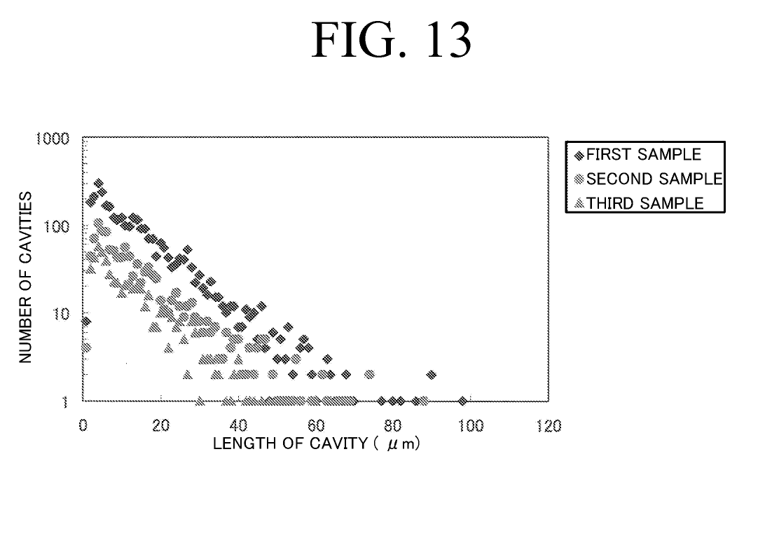

Comparing the samples shown in FIGS. 4 to 9, practically identical cavities are seen in the samples, and these photos do not clearly confirm a correlation with permeance. However, all the cavities that have appeared in the porous body have a spherical or ellipsoidal shape similar to the inner surface of a balloon. Further, where a cavity (bubble) is present independently, it is connected to another cavity. Holes with a diameter less than that of cavities are open in the cavities and the cavities are linked to each other by the holes. FIG. 13 is a graph illustrating the results obtained in image analysis.

In this analysis, 3 mm×3 mm specimens were cut out from the first to third samples and cavities were analyzed. In the graph, the results obtained for the first, second, and third sample are presented by squares, circles, and triangles, respectively. A cavity length is plotted against the abscissa of the graph. The number of cavities is plotted against the ordinate of the graph. In other words, the graph shows the number of cavities present per cavity length. For example, in a 3 mm×3 mm×2 mm specimen of the first sample, about 60 cavities with a length of 20 μm were present. This graph indicates that the sample with a small permeation time tended to have a large number of cavities and a large maximum size.

In other words, where gas permeability is good, the number of cavities tends to be large and the size of the cavities tends to be large. As can be seen from the photos, cavities in the samples are linked together. This is apparently why the gas easily permeates through the material. The number of cavities related to the cavity size that is determined from the graph is shown in Table 3 below. In Table 3, the diameter is the cavity size. For example, in the first sample, there are eight cavities with a diameter of 1 μm and 105 cavities with a diameter of 10 μm. The cavity size was divided into two ranges: from 1 μm to 10 μm and from 11 μm to 20 μm, and the ratio of the number of cavities in each range to the total number of cavities was calculated.

The number of cavities with a diameter of from 1 μm to 10 μm was about 52% in the first sample, about 52% in the second sample, and about 56% in the third sample. Basically, it can be said that the number of cavities with a diameter of from 1 μm to 10 μm is 50% to 60%. Likewise, the number of cavities with a diameter of from 11 μm to 20 μm is about 27% in the first sample, about 28% in the second sample, and about 27% in the third sample. Likewise, the number of cavities with a diameter of from 21 μm to 30 μm is about 12% in the first sample, about 11% in the second sample, and about 11% in the third sample. Likewise, the number of cavities with a diameter of from 31 μm to 41 μm is equal to or less than 5% in each of the first to third samples.

The number of cavities with a diameter of from 11 μm to 30 μm is from about 38% to 40% in the first to third samples. The number of cavities with a diameter of from 31 μm to 100 μm is 5 to 9% in each of the first to third samples.

TABLE 3

| | Diameter μm | | | | | | | | | |
|---|---|---|---|---|---|---|---|---|---|---|
| | 1 | 2 | 3 | 4 | 5 | 6 | 7 | 8 | 9 | 10 |
| ♦ | 8 | 180 | 210 | 300 | 230 | 170 | 165 | 105 | 104 | 105 |
| • | 4 | 45 | 70 | 100 | 85 | 84 | 53 | 52 | 43 | 43 |
| Δ | 0 | 30 | 40 | 55 | 50 | 40 | 27 | 21 | 21 | 16 |
| | Diameter μm | | | | | | | | | |
| | 11 | 12 | 13 | 14 | 15 | 16 | 17 | 18 | 19 | 20 |
| ♦ | 95 | 95 | 105 | 104 | 92 | 92 | 70 | 70 | 45 | 60 |
| • | 55 | 45 | 25 | 36 | 22 | 30 | 33 | 27 | 24 | 13 |
| Δ | 20 | 21 | 18 | 19 | 18 | 11 | 15 | 7 | 7 | 10 |
| | Diameter μm | | | | | | | | | |
| | 21 | 22 | 23 | 24 | 25 | 26 | 27 | 28 | 29 | 30 |
| ♦ | 55 | 45 | 35 | 37 | 41 | 40 | 51 | 32 | 22 | 28 |
| • | 11 | 10 | 13 | 17 | 12 | 12 | 12 | 13 | 9 | 8 |
| Δ | 10 | 4 | 9 | 7 | 8 | 5 | 2 | 8 | 6 | 1 |
| | Diameter μm | | | | | | | | | |
| | 31 | 32 | 33 | 34 | 35 | 36 | 37 | 38 | 39 | 40 |
| ♦ | 19 | 16 | 22 | 15 | 15 | 12 | 10 | 12 | 12 | 7 |
| • | 6 | 8 | 6 | 7 | 3 | 3 | 6 | 4 | 5 | 5 |
| Δ | 3 | 3 | 3 | 2 | 2 | 0 | 1 | 1 | 2 | 3 |
| | Diameter μm | | | | | | | | | |
| | 41 | 42 | 43 | 44 | 45 | 46 | 47 | 48 | 49 | 50 |
| ♦ | 7 | 11 | 9 | 10 | 5 | 12 | 4 | 1 | 6 | 3 |
| • | 2 | 2 | 4 | 2 | 4 | 5 | 5 | 0 | 2 | 1 |
| Δ | 0 | 1 | 1 | 1 | 0 | 1 | 0 | 2 | 0 | 1 |
| | Diameter μm | | | | | | | | | |
| | 51 | 52 | 53 | 54 | 55 | 56 | 57 | 58 | 59 | 60 |
| ♦ | 5 | 3 | 7 | 2 | 0 | 4 | 5 | 4 | 2 | 1 |
| • | 1 | 1 | 1 | 1 | 3 | 1 | 0 | 0 | 1 | 0 |
| Δ | 0 | 0 | 0 | 0 | 0 | 0 | 0 | 0 | 0 | 1 |
| | Diameter μm | | | | | | | | | |
| | 61 | 62 | 63 | 64 | 65 | 66 | 67 | 68 | 69 | 70 |
| ♦ | 0 | 0 | 3 | 2 | 1 | 0 | 1 | 2 | 1 | 1 |
| • | 0 | 2 | 1 | 0 | 0 | 1 | 0 | 1 | 1 | 0 |
| Δ | 0 | 0 | 0 | 1 | 0 | 0 | 0 | 0 | 0 | 0 |
| | Diameter μm | | | | | | | | | |
| | 71 | 72 | 73 | 74 | 75 | 76 | 77 | 78 | 79 | 80 |
| ♦ | 0 | 0 | 0 | 0 | 0 | 0 | 1 | 0 | 0 | 1 |
| • | 0 | 0 | 0 | 2 | 0 | 0 | 0 | 0 | 0 | 0 |
| Δ | 0 | 0 | 0 | 0 | 0 | 0 | 0 | 0 | 0 | 0 |
| | Diameter μm | | | | | | | | | |
| | 81 | 82 | 83 | 84 | 85 | 86 | 87 | 88 | 89 | 90 |
| ♦ | 0 | 1 | 0 | 0 | 0 | 1 | 0 | 0 | 0 | 2 |
| • | 0 | 0 | 0 | 0 | 0 | 0 | 0 | 1 | 0 | 0 |
| Δ | 0 | 0 | 0 | 0 | 0 | 0 | 0 | 0 | 0 | 0 |
| | Diameter μm | | | | | | | | | |
| | 91 | 92 | 93 | 94 | 95 | 96 | 97 | 98 | 99 | 100 |
| ♦ | 0 | 0 | 0 | 0 | 0 | 0 | 0 | 1 | 0 | 0 |
| • | 0 | 0 | 0 | 0 | 0 | 0 | 0 | 0 | 0 | 0 |
| Δ | 0 | 0 | 0 | 0 | 0 | 0 | 0 | 0 | 0 | 0 |

### [Analysis of Internal Structure of Porous Molded Article]

As demonstrated by the above-described observation examples, spherical or ellipsoidal cavities are dispersed in the porous molded article. The cavity is a hollow space that has appeared inside the porous molded article. The cavities may be isolated and present independently from each other, or may be connected by very fine pipes. The porous molded article has gas permeability. In other words, a gas passes from inlet to the outlet of a porous molded article sample.

In other words, the gas permeates through the entire sample, while passing inside the connected cavities in the porous molded body. As shown in the above-described figures, the cavities are connected by fine communication paths (pipes). When the cavities are connected together, a configuration similar to a peanut shell is assumed and the cavities communicate with each other inside the sample. The cavities communicate with other cavities in less than half of the internal surface area. As can be seen from the photos of porous molded articles, not all of the cavities present inside the porous molded body are connected. Thus, only some of the cavities are connected together. Accordingly, the inside of the porous molded article can be assumed to be composed of communicating open passages that pass in a meandering fashion between the inlet and outlet of the porous structural body and that are composed of cavities joined with each other in a chain configuration, and chain closed passages.

The chain closed passages include those connected to the communicating open passages and those that are not connected to the communicating open passages. The chain closed passages that are not connected to the communicating open passages are composed of one cavity or a plurality of cavities. As follows from the above-described measurement results, 50% or less of all the cavities located inside the porous structural body constitute communicating open passages or connected to the communicating open passages. The porous molded body is air permeable but impermeable to liquids such as water. The reason therefor can be explained as described below. Let us consider two cavities that are connected together. The air initially enters one cavity. Physically speaking, the outside of the cavity is under a higher pressure and the inside of the cavity is the low-pressure air.

Where the air pressure rapidly changes from a high pressure to a low pressure, adiabatic expansion occurs, the air is cooled, and vapors contained in the air are jetted out, become a liquid and adhere to the cavity walls or the like. Further, the air flows through the communicating open passages in the porous molded body from a high-pressure side to a low-pressure side. In this case, a case will be considered in which one of the two cavities that are connected together by a fine pipe is under a high pressure and the other is under a low pressure. When the air flows from the cavity under a high pressure to the cavity under a low pressure, the air is adiabatically compressed in the pipe between the cavities and adiabatically expands upon entering into the cavity under a low pressure.

In this case, when adiabatic expansion takes palace, the air is cooled, vapors contained in the air become water, and this water adheres to the cavity wall surface or the like. When the air permeates through the communicating open passages inside the porous molded body, cycles of adiabatic compression and adiabatic expansion are repeated, the air advances through the communicating open passages, while moisture contained therein is blown off, and eventually permeates through the porous molded body as dry air containing no water vapors or moisture. The air that has permeated through the porous molded article contains no vapors or moisture or contains a very small amount thereof. The case will be considered below in which the porous molded article constitutes one or more wall surfaces of a container.

The following mode of use for the container can be easily assumed. For example, the porous molded body is a vent plug in a headlamp for an automobile. the automobile headlamp has a semi-sealed structure and an electric lamp located therein is a heat source. When the electric lamp is turned on, the air inside the headlamp is heated, and when the electric lamp is turned off, the heated air is cooled. Therefore, the headlamp is subjected to cyclic actions such as expansion when the air is heated and compression when the air is cooled. Therefore, an air-permeable material is used for a wall surface of the headlamp and temperature adjustment is conducted to avoid such cycles as effectively as possible.

Thus, considered below will be a container, such as an automobile headlamp, that is required to be semi-sealable, impermeable to liquids, and permeable to gases such as air. Further, a case will be assumed in which a heat source is present inside or outside the container and the container is heated thereby. In the initial state, the atmosphere inside the container is in a state of thermal equilibrium with the atmosphere outside the container, and practically no air flows from the inside of the container to the outside of the container, or in the opposite direction. Diffusion occurs due to a difference in concentration of substances in the air, but the air flow may be assumed to be absent. However, when the air inside the container is heated by the heat source and the air temperature rises, the momentum of the air inside the container increases and the pressure inside the container becomes higher than that outside the container.

As a result, the air contained inside the container thermally diffuses from the inside of the container to the outside of the container to restore thermal equilibrium. Where the heat source is turned off, conversely, thermal diffusion, that is, the air flow, starts from the outside of the container to the inside of the container, and the air permeates through the porous molded articles. The concentration of vapors is usually higher outside the container than inside the container. For example, a critical state is assumed when it is raining. In this case, the concentration of vapors is much higher outside the container than inside the container. Where the air enters from the outside of the container and flows into a cavity of a communicating open passage, the air passes through, while the above-described adiabatic expansion is repeated. Water vapors undergo phase transformation inside the cavity and become water droplets that are retained in the cavity.

Such a process continues till thermal equilibrium is established between the container, the porous molded body, and the outside air. Where the heat source is now further heated, the air flows from the inside of the container into the cavity of the communicating open passage and permeates, while the above-described adiabatic expansion is repeated. However, water and water droplets retained in the cavity move little by little to the outside. As a result, when the heat source is present in the sealed container, water vapors contained in the sealed container and communicating open passages continuously flow to the outside. When the heat source is turned off, the sealed container and porous molded article are continuously cooled to restore thermal equilibrium with the outside air.

Where the communicating passage is sufficiently long, when the air advances, while undergoing thermal expansion in each cavity through which the air passes, and enters the sealed container, the air contains practically no water vapors. The same is true when the external air contains water vapor and mist at a very high concentration. The air permeates the porous molded article, while the water contained in the air is discharged therefrom during adiabatic expansion, till thermal equilibrium is assumed, and when the air enters the container, the air is dry. Adiabatic expansion inside the porous molded body occurs when the pipes connecting the cavities to each other are fine. Obviously, it cannot be denied that water vapors contained in the air come into contact with cavity walls and adhere to the walls under the effect of thermal tension.

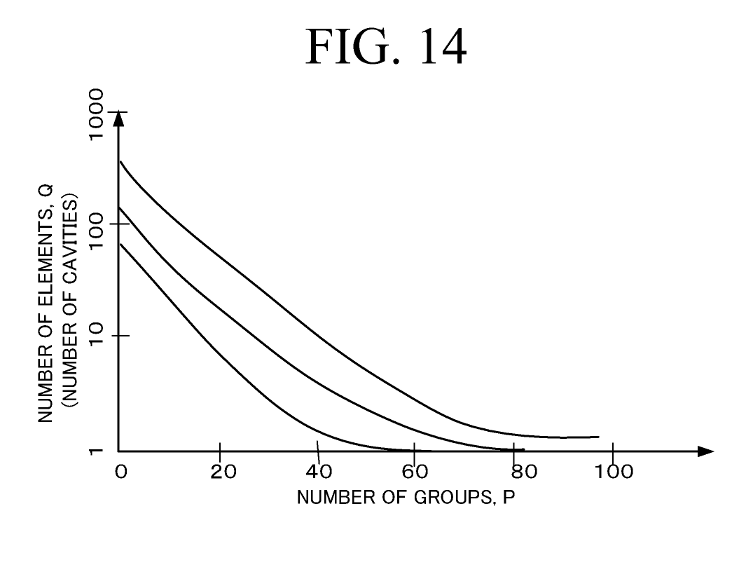

Further, it is also undeniable that water vapors adhere under the effect of thermal tension to the water that has already adhered to the cavity walls. The trend in the graph shown in FIG. 13 can be patterned as shown in FIG. 14. Here, P plotted against the abscissa is a number of groups indicating the connection number of cavities and the number of cavities. Q plotted against the ordinate represents the number of cavities of the same size and is taken as a number of elements in one group. The sum total of the numbers of all the cavities is the total number of elements; it is denoted by N. The smallest number of groups that can be actually taken is 1 and the maximum number of groups is N. A case will be considered in which the number of elements in all the groups is the same (the case of a single cavity). In this case, the total number of elements N can be represented as follows.

P·Q=N [Eq. 1]

In this case, the relationship with each number of groups and number of elements is such as shown in Table 4.

TABLE 4

| | | | | |
|---|---|---|---|---|
| Number of | 1 | 2 | . . . | N |
| Groups | | | | |
| Number of | N | N/2 | . . . | 1 |
| Elements | | | | |

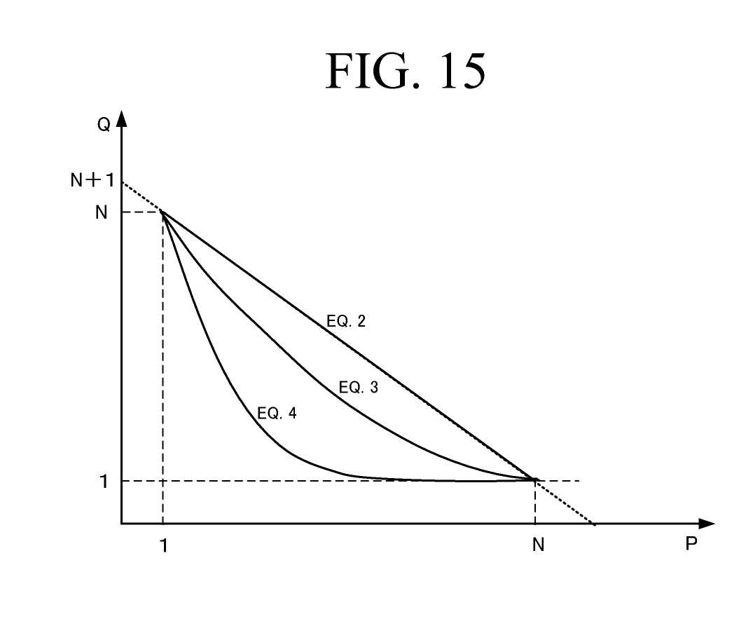

The graph in which the minimum number of groups 1 and the maximum number of groups N that can be actually taken are represented by a straight line is represented by the following Eq. 2 (see FIG. 15). When N is sufficiently high, N is substantially equal to N+1. They are identical at least technically.

Q=−P+(N+1) [Eq. 2]

It is obvious that Q represented by Eq. 1 is smaller than Q represented by Eq. 2 for any P. These Eq. 1 and Eq. 2 show probability dispersions. When N is extremely large, for example, when cavities with a diameter of 10 μm are present in 1 cm³, the maximum number of the cavities is 1 billion.

(10 cm)/(10 μm)³=10⁹

Typically, the total number N_{T} of N can be determined from the following Eq. 3.

$$\begin{matrix}{N}_{T} = {\int }_{1}^{N} Q d P \\ = {\int }_{1}^{N} \frac{N}{P} d P \\ = {N [ Ln P ]}_{1}^{N} \\ = N \cdot Ln N\end{matrix} \qquad [ Eq . 3 ]$$

Actually, when N is even larger, the attenuation ratio of the number of elements Q is also even larger. In this case, the number of elements Q is represented by the following Eq. 4.

Q=N·exp(−P) [Eq. 4]

Likewise, the total number N_{T} of N can be determined from the following Eq. 5.

$$\begin{matrix}{N}_{T} = \int Q d P \\ = {[ - N {e}^{- p} ]}_{0}^{∞} \\ = - N {e}^{∞} - ( - N {e}^{0} ) \\ = - N \cdot 0 - ( - N \cdot 1 ) \\ = N\end{matrix} \qquad [ Eq . 5 ]$$

In the case of Eq. 2 above, the following Eq. 6 is obtained.

$$\begin{matrix}{N}_{T} = {\int }_{1}^{N} Q d P \\ = {[ - \frac{1}{2} {P}^{2} + ( N + 1 ) P ]}_{1}^{N} \\ = ( - \frac{1}{2} {N}^{2} + ( N + 1 ) N ) - ( - \frac{1}{2} {1}^{2} + ( N + 1 ) \cdot 1 ) \\ = ( - \frac{1}{2} {N}^{2} + ( N + 1 ) N ) - ( - \frac{1}{2} {1}^{2} + ( N + 1 ) \cdot 1 ) \\ = ( \frac{1}{2} {N}^{2} + N ) - ( N + \frac{1}{2} ) \\ = \frac{1}{2} {N}^{2} - \frac{1}{2} \\ \approx \frac{1}{2} {N}^{2}\end{matrix} \qquad [ Eq . 6 ]$$

In the graph shown in FIG. 15, the total number N_{T} is less than that represented by Eq. 2 and larger than that represented by Eq. 4. In general, Eq. 3 is appropriate. This is the relationship between P and Q, the coefficient being less than that represented by Eq. 2 and a total number being larger than that represented by Eq. 4.

N_{T}=LnN·N [Eq. 7]

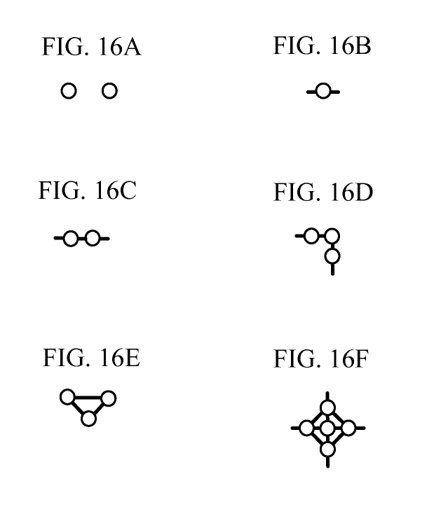

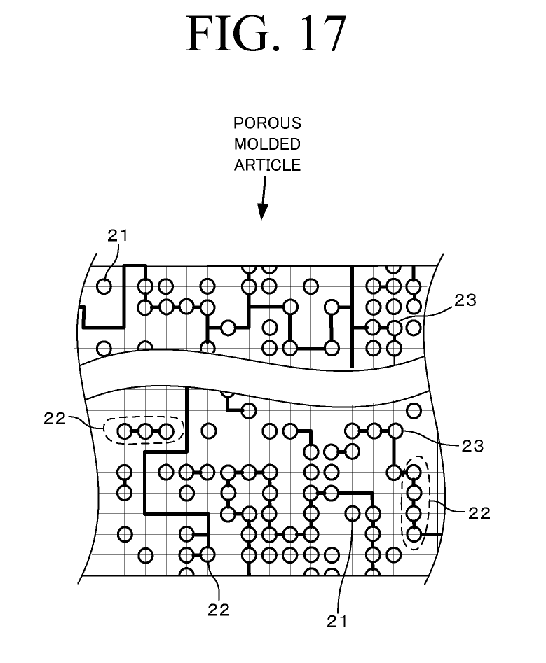

In FIGS. 16A-F, cavities of each element constituting the internal structure of the porous structural body are schematically represented. In FIG. 17, the internal structure of the porous structural body is schematically represented. FIG. 17 graphically represents the cavities. In the figure, the cavities of the same size are arranged in a regular order to facilitate understanding. The cavities shown in FIG. 17 and connections thereof can be classified to the type such as shown graphically in FIGS. 16A-F. FIG. 16A shows a configuration in which cavities are present independently from each other. A cavity 21 in FIG. 17 is an example of such cavities.

As shown in FIG. 16B, the cavities are connected to other cavities by pipes linked thereto. As a result, a chain composed of a plurality of connected cavities is produced. Depending on how the cavities are connected, this chain can be a simple chain shown in FIG. 16C, a straight chain shown in FIG. 16D, an annular chain shown in FIG. 16E, or a centered annular chain shown in FIG. 16F. The simple chain shown in FIG. 16C is represented by a reference number 22 in FIG. 17. The straight chain shown in FIG. 16D is represented by a reference number 23 in FIG. 17. In the porous structural body, cavities present therein form communication paths and non-communication paths. A communication path is composed of a linear communication path and a chain non-linear communication path. A non-communication path is composed of an annular path and a non-annular path.

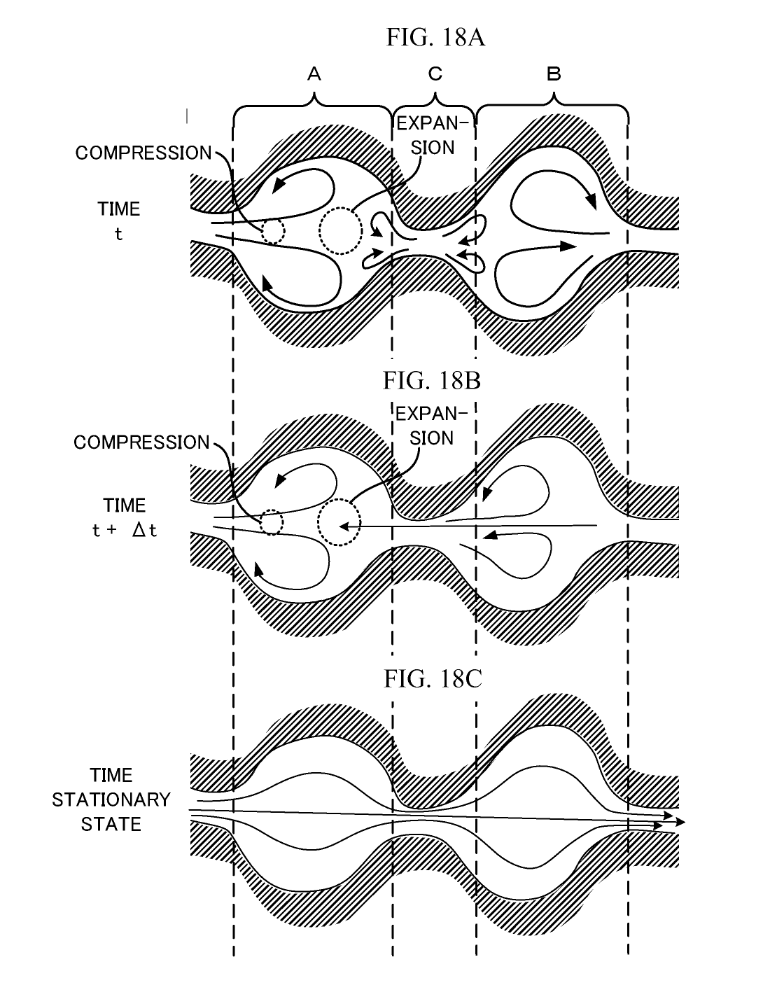

FIGS. 18A to 18C show schematically how the air passes through a communication path composed of a cavity A and a cavity B. In the figure, “Expansion” and “Contraction” represent the state of the air. The arrows in the figure indicate the directions in which the air flows. Thus, FIG. 18A represents a state at a point in time t in which the fluid starts entering the cavity. As shown in the figure, the fluid in the porous structural body is in the non-stationary state. Therefore, the fluid flows in from both sides of the cavity and flow turbulence irregularly occurs in the air inside the cavity. Where the air flows into the cavity A, the air enters in a state of compression (since the air has passed through a fine pipe) and expands in the course of advancing to the cavity B.

Further, since the pipe C is fine, part of the air enters the pipe C, whereas the air that has not entered the pipe C returns along the wall surface of the cavity A, thereby causing turbulence. Here, this air collides with the air that entered the cavity A thereafter and is compressed. Then, as shown in FIG. 18B, the air also flows back from the cavity B. Thus, the fluid inside the cavity performs an extremely complex movement. Local behavior of the fluid is very difficult to estimate, but when the entire porous structural body is considered, general statistical predictions are possible. Under the pressure of the fluid flowing inside the cavity, the cavity is expanded and contracted and eventually assumes a stationary state as shown in FIG. 18C.

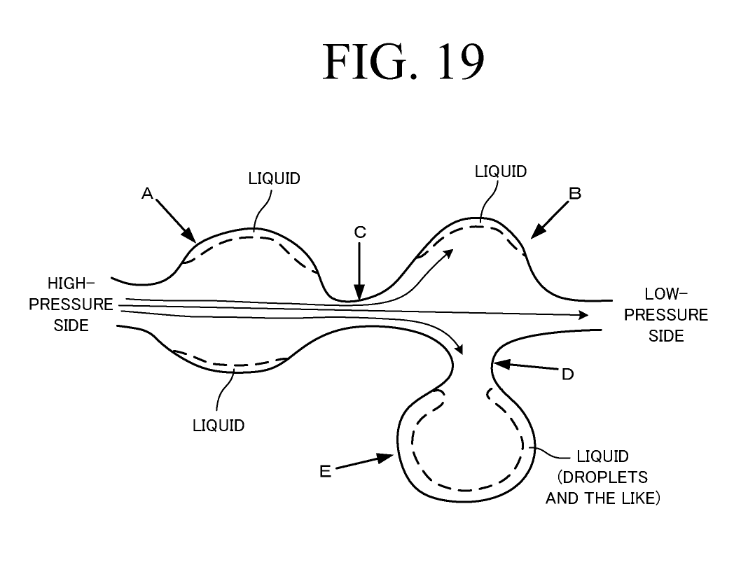

In the stationary state, the fluid flows substantially in one direction, as shown in FIG. 18C, and a constant flow is realized in the cavities and passages connecting one cavity to another. When the air flows into a cavity A and a cavity B and expands, moisture contained in the air is discharged due to adiabatic explanation and remains inside the cavity A and the cavity B. FIG. 19 shows a state in which the fluid flows in a communication path that is connected to a non-communication path. The communication path is composed of the cavity A and the cavity B, and the air flows from the high-pressure side to the low-pressure side. A case is shown in which the air pressure fluctuates inside the porous structural body or at both sides of the porous structural body. The gas flows from the zone with a high pressure to that with a low pressure.

In the example of the non-communicating passage shown in the figure, the passage is composed of one cavity E connected to the cavity B. The cavity A and the cavity B are connected by the pipe C. The cavity B and the cavity E are connected by the pipe D. When the air flowing in the communicating passage and the air inside the cavity E have the same air pressure, a stationary state is assumed. As also shown in the example illustrated by FIGS. 18A-C described above, when the air starts flowing in the cavity E, the air enters into the cavity E and expands, or sometimes contracts, and a stationary state is assumed. In certain cases, when the fluid flows in the cavity A and the cavity B, the expansion and compression cycles in the cavity E are repeated due to fluctuations of air pressure.

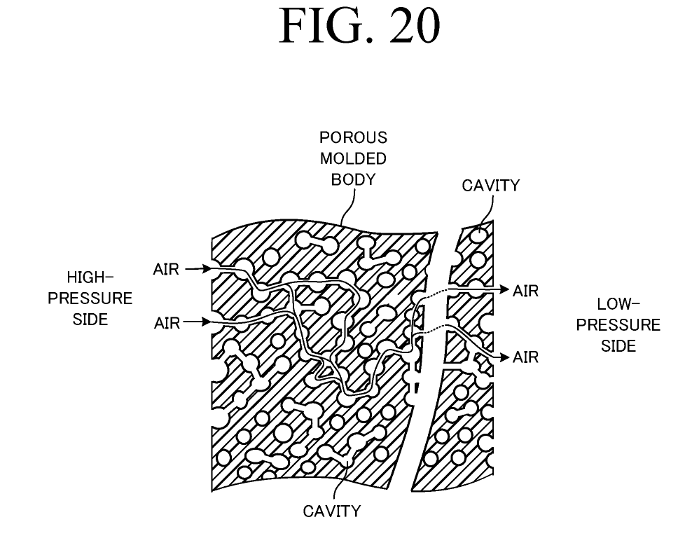

When the air flows into the cavity E and expands, moisture contained in the air is discharged due to adiabatic expansion and stays inside the cavity E. Thus, the vapors contained in the gas enter the cavities contained in the non-communicating passage or communicating open passage and stay therein. This is the dehumidification effect. As a result of such operations, moisture variations reach a saturation level. Impurities contained in the air, similarly to the above-described vapors, enter the cavities of non-communicating passages and stay therein. Therefore the air percolation and filtration effects can be also expected. FIG. 20 shows an example in which the fluid flows in the communicating passage of the porous structural body.

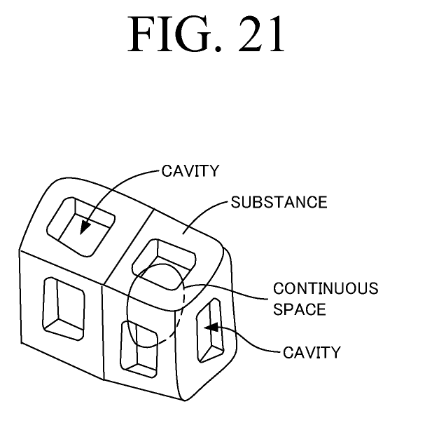

For example, the fluid flows in a complex flow path, as shown by arrows, and passes through the porous structural body. A highly curved flow path makes it possible to expect the above-described dehumidification, percolation, and filtration effects. FIG. 21 shows a sponge structural body. The conventional porous structural body has such a sponge-like structure. As shown in the figure, spaces are opened in a substance composed of a porous body. This sponge structure is different from the porous structural body in accordance with the present invention. The sponge structure is composed of various closed three-dimensional bodies that can be connected. As shown in the figure, spaces contained in the sponge substance are mutually connected and envelop the substance.

The spaces contained in the sponge substance are isolated spaces, rather than cavities. By contrast, in the filter in accordance with the present invention, the cavities are connected in an annular or spherical form and do not envelop the substance portion. The conventional configuration has a low degree of expansion and contraction. The present invention can ensure chain-like expansion and contraction.

The present invention has high applicability to the fields of porous molded articles for ensuring the internal pressure and preventing water penetration and also to the fields of moving machines, electronic devices, electric apparatuses, general machinery, illumination devices and other general manufacturing fields using semi-sealed containers provided with the porous molded articles. In particular, the present invention may be effectively applied to vent plugs for use in case components of headlamp or backlight of an automobile, and cases of electronic devices or rotary machines such as motors of electric appliances, and to materials for the vent plugs.

What is claimed is:

1. A porous structural body for a vent plug, wherein
a cross section of the porous structural body has an overall structure entirely occupied by a structure composed of an infinite number of spherical or ellipsoidal cavities having a diameter of 1 μm to 100 μm, when observed under an electron microscope, and
the structural body is of a continuous bubble type in which one or more holes are open in walls of each of the cavities and the cavity is linked to another cavity by the holes.

2. A porous structural body for a vent plug, wherein
the inside of the porous structural body having spherical or ellipsoidal cavities dispersed therein is constituted by
communicating open passages that pass in a meandering fashion between an outlet and an inlet of the porous structural body and are composed of a plurality of the cavities that are joined with each other in a chain configuration, and
chain closed passages that are composed of one cavity or a plurality of the cavities and connected to the communicating open passages, and
some or all of the cavities communicate with other cavities by a volume equal to or less than half of the volume of the cavity.

3. The porous structural body for a vent plug according to claim 2, wherein
equal to or less than 50% of all the cavities inside the porous structural body constitute the communicating open passages and the chain closed passages connected to the communicating open passages.

4. The porous structural body for a vent plug according to any one of claims 1 to 3, wherein
50 to 60% of the cavities per unit cube are the cavities having a diameter less than 10 μm.

5. The porous structural body for a vent plug according to claim 4, wherein
35 to 45% of the cavities per unit cube are the cavities having a diameter of 11 to 30 μm.

6. The porous structural body for a vent plug according to claim 4, wherein
5 to 15% of the cavities per unit cube are the cavities having a diameter of 31 to 100 μm.

7. The porous structural body for a vent plug according to any one of claims 1 to 3, wherein
the cavity is a continuous passage constituted by a first cavity with an effective diameter A and a second cavity with an effective diameter B that is less than the effective diameter A, and
the first cavity is determined by the number P of groups and number Q of elements within a region between
Q=−P+N
and
Q=N·exp(−P).

8. The porous structural body for a vent plug according to any one of claims 1 to 3, which is manufactured by
producing a molded article composed of 60 to 85 parts by weight of pentaerythritol, 15 to 40 parts by weight of a polybutylene terephthalate resin, and 0.25 to 3 parts by weight of at least one species selected from a polyfunctional alcohol that is liquid at normal temperature, polyethylene glycol, and polypropylene glycol, and
immersing the molded article into water, thereby dissolving in water and removing water-soluble components contained in the molded article, to form a porous body having gas permeability in the molded article.

9. The porous structural body for a vent plug according to claim 8, wherein
in order to increase water resistance, the molded article after immersion into the water is immersed into a benzine solution of a methyl silicone polymer and then dried, thereby causing the methyl silicon polymer to adhere to a surface of the porous body and to an internal wall of a hole inside the porous body.
